(19) United States
(12) Patent Application Publication
(10) Pub. No.: US 2013/0336406 A1
(43) Pub. Date: Dec. 19, 2013

(54) REDUNDANCY REMOVAL FOR MERGE/SKIP MODE MOTION INFORMATION CANDIDATE LIST CONSTRUCTION

(71) Applicant: QUALCOMM INCORPORATED, SAN DIEGO, CA (US)

(72) Inventors: LI ZHANG, SAN DIEGO, CA (US); YING CHEN, SAN DIEGO, CA (US); MARTA KARCZEWICZ, SAN DIEGO, CA (US)

(21) Appl. No.: 13/917,291

(22) Filed: Jun. 13, 2013

Related U.S. Application Data
(60) Provisional application No. 61/659,900, filed on Jun. 14, 2012.
(60) Provisional application No. 61/666,629, filed on Jun. 29, 2012.

(51) Int. Cl. H04N 7/34

(52) U.S. Cl. CPC H04N 19/00763
USPC 375/240.16

(57) ABSTRACT

In general, techniques are described for constructing a merging candidate list for coding video data according to a merge mode and/or a skip mode. In some examples, the techniques include identifying one or more spatial merging candidates (SMCs) and an inter-view merging candidate (IVMC) for inclusion in a merging candidate list, and comparing the motion information of at least one of the SMCs to the motion information of the IVMC. In such examples, if the SMC has the same motion information as the IVMC, the techniques may further include pruning the merging candidate list to exclude the one of the merging candidates from the merging candidate list.

This application claims the benefit of U.S. Provisional Application No. 61/666,629, filed Jun. 29, 2012, and U.S. Provisional Application No. 61/659,900, filed on Jun. 14, 2012, the entire content of both of which is incorporated herein by reference.

### TECHNICAL FIELD

This disclosure relates to video coding and, more particularly, to motion information prediction in video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal or view (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, techniques are described for constructing a merging candidate list for coding video data, e.g., encoding or decoding video data, according to a merge mode and/or a skip mode. In some examples, the techniques include identifying one or more spatial merging candidates (SMCs) and an inter-view merging candidate (IVMC) for inclusion in a merging candidate list, and comparing the motion information of at least one of the SMCs to the motion information of the IVMC. In such examples, if the SMC has the same motion information as the IVMC, the techniques may further include pruning the merging candidate list to exclude the one of the merging candidates from the merging candidate list.

In one example, a method of decoding video data according to a merge mode and/or a skip mode comprises identifying one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The method further comprises comparing the motion information of at least one of the SMCs to the motion information of the IVMC and, if the SMC has the same motion information as the IVMC, pruning the merging candidate list to exclude the one of the merging candidates from the merging candidate list. The method further comprises decoding an index that refers to one of the merging candidates from the merging candidate list for the current video block, and decoding the current video block based on the one of the merging candidates from the merging candidate list referenced by the index.

In another example, a method of encoding video data according to a merge mode and/or a skip mode comprises identifying one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The method further comprises comparing the motion information of at least one of the SMCs to the motion information of the IVMC and, if the SMC has the same motion information as the IVMC, pruning the merging candidate list to exclude the one of the merging candidates from the merging candidate list. The method further comprises encoding an index that refers to one of the merging candidates from the merging candidate list for the current video block, and encoding the current video block based on the one of the merging candidates from the merging candidate list referenced by the index.

In another example, a device that decodes video data according to a merge mode and/or a skip mode comprises a video decoder configured to identify one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The video decoder is further configured to compare the motion information of at least one of the SMCs to the motion information of the IVMC and, if the SMC has the same motion information as the IVMC, prune the merging candidate list to exclude the one of the merging candidates from the merging candidate list. The video decoder is further configured to decode an index that refers to one of the merging candidates from the merging candidate list for the current video block, and decode the current video block based on the one of the merging candidates from the merging candidate list referenced by the index.

In another example, a device that encodes video data according to a merge mode and/or a skip mode comprises a video encoder configured to identify one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The video encoder is further configured to compare the motion information of at least one of the SMCs to the motion information of the IVMC and, if the SMC has the same motion information as the IVMC, prune the merging candidate list to exclude the one of the merging candidates from the merging candidate list. The video encoder is further configured to encode an index that refers to one of the merging candidates from the merging candidate list for the current video block, and encode the current video block based on the one of the merging candidates from the merging candidate list referenced by the index.

In another example, a device that codes video data according to a merge mode and/or a skip mode comprises means for identifying one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The device further comprises means for comparing the motion information of at least one of the SMCs to the motion information of the IVMC, and means for, if the SMC has the same motion information as the IVMC, pruning the merging candidate list to exclude the one of the merging candidates from the merging candidate list. The device further comprises means for coding an index that refers to one of the merging candidates from the merging candidate list for the current video block, and means for coding the current video block based on the one of the merging candidates from the merging candidate list referenced by the index.

In another example, a computer-readable storage medium has instructions stored thereon that, when executed by one or more processors of a video coder, cause the video coder to identify one or more spatial merging candidates (SMCs) and an inter-view merging candidate (IVMC) for inclusion in a merging candidate list for a current video block in a first view of a current access unit of video data. The SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. The instructions further cause the video coder to compare the motion information of at least one of the SMCs to the motion information of the IVMC and, if the SMC has the same motion information as the IVMC, prune the merging candidate list to exclude the one of the merging candidates from the merging candidate list. The instructions further cause the video coder to code an index that refers to one of the merging candidates from the merging candidate list for the current video block, and code the current video block based on the one of the merging candidates from the merging candidate list referenced by the index.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example encoding and decoding system that may be configured to utilize the techniques described in this disclosure for constructing a merging candidate list for coding video data according to a merge mode and/or a skip mode.

FIG. 2 is a conceptual diagram illustrating an example current video block in relation to a plurality of spatially-neighboring blocks from which spatial merging candidates (SMCs) for the current block may be derived.

FIG. 3 is a conceptual diagram illustrating an example picture including a current video block, and a temporal reference picture including a reference block from which a temporal merging candidate (TMC) may be derived.

FIG. 4 is a conceptual diagram illustrating example pictures of a plurality of access units, each access unit including a plurality of views, and derivation of an inter-view merging candidate (IVMC).

FIGS. 5-8 are flow diagrams illustrating example techniques for constructing a merging candidate list for a current block of video data.

FIG. 9 is a block diagram illustrating an example of a video encoder that may implement the techniques described in this disclosure for constructing a merging candidate list.

FIG. 10 is a block diagram illustrating an example of a video decoder that may implement the techniques described in this disclosure for constructing a merging candidate list.

### DETAILED DESCRIPTION

The techniques described in this disclosure are generally related to three-dimensional (3D) video coding, e.g., the coding of two or more views. More particularly, the techniques are related to 3D video coding using a multiview coding (MVC) process, such as an MVC plus depth process. For example, the techniques may be applied to a 3D-HEVC encoder-decoder (codec) in which MVC or MVC plus depth coding processes are used. An HEVC extension for 3D-HEVC coding processes is currently under development and, as presently proposed, makes use of MVC or MVC plus depth coding processes. Additionally, the techniques described in this disclosure are related to constructing a list of motion information candidates for a current block of video data according to a motion information prediction mode, such as the merge and skip modes, in the context of 3D video coding, such as the 3D video according to 3D-HEVC, where the list includes inter-view merging candidate (IVMC) derived from a different view than the current view that includes the current video block. Although primarily described in the context of 3D-HEVC, the techniques described herein may be implemented by video codecs configured according to any of a variety of video coding standards, including the standards described in this disclosure.

As one example, the techniques described in this disclosure may be implemented by an HEVC codec configured to perform 3D-HEVC coding processes, as discussed above. However, other example video coding standards that possibly could be extended or modified for use with the techniques of this disclosure include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. A joint draft of MVC is described in “Advanced video coding for generic audiovisual services,” ITU-T Recommendation H.264, March 2010, which as of Jun. 4, 2013 is downloadable from http://www.itu.int/ITU-T/recommendations/rec.aspx?id=10635.

HEVC is currently being developed by the Joint Collaboration Team on Video Coding (JCT-VC) of ITU-T Video Coding Experts Group (VCEG) and ISO/IEC Motion Picture Experts Group (MPEG). A recent draft of HEVC is available from: http://wg11.sc29.org/jct/doc_end_user/current_document.php?id=5885/JCTVC-11003-v2. Another recent draft of the HEVC standard, referred to as “HEVC Working Draft 7” is downloadable from: http://phenix.it-sudparis.eu/jct/doc_end_user/documents/9_Geneva/wg11/JCTVC-11003-v3.zip, as of Jun. 6, 2012. The full citation for the HEVC Working Draft 7 is document HCTVC-11003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9^{th} Meeting: Geneva, Switzerland, Apr. 27, 2012 to May 7, 2012.

Examples of the HEVC-based 3D Video Coding (3D-HEVC) codec presently under development by the Motion Pictures Expert Group (MPEG) are described in MPEG documents m22570 and m22571. The latest reference software HM version 3.0 for 3D-HEVC can be downloaded from the following link: https://hevc.hhi.fraunhofer.de/svn/svn_{—}3DVCSoftware/tags/HTM-3.0/. The full citation for m22570 is: Schwarz et al., Description of 3D Video Coding Technology Proposal by Fraunhofer HHI (HEVC compatible configuration A), MPEG Meeting ISO/IEC JTC1/SC29/WG11, Doc. MPEG11/M22570, Geneva, Switzerland, November/December 2011. The full citation for m22571 is: Schwarz et al., Description of 3D Video Technology Proposal by Fraunhofer HHI (HEVC compatible; configuration B), MPEG Meeting—ISO/IEC JTC1/SC29/WG11, Doc. MPEG11/M22571, Geneva, Switzerland, November/December 2011.

Each of the preceding references is incorporated herein by reference in their respective entireties. The techniques described in this disclosure are not limited to these standards, and may be extended to other standards, including standards that rely upon motion information prediction for video coding.

In general, a multiview or 3D video sequence may include, for each access unit (i.e., with the same time instance), two or more pictures for each of two or more views, respectively. Inter-view prediction may be allowed among pictures that are from different views, but in the same access unit or time instance. In the context of multiview coding, there are at least two kinds of motion vectors. One is a normal motion vector pointing to a temporal reference picture that is in the same view but from a different access unit or time instance than the current picture that includes the current video block. The inter-picture prediction based on a normal motion vector may be referred to as motion-compensated prediction (MCP). Another type of motion vector in multiview coding is a disparity motion vector that points to a reference picture in a different view but in the same access unit or time instance as the current picture that includes the current video block. The inter-picture prediction based on a disparity motion vector may be referred to as disparity-compensated prediction (DCP).

Merge mode is a video coding mode in which motion information (such as motion vectors, reference frame indexes, prediction directions, or other information) of a neighboring video block are inherited for a current video block being coded. A skip mode, in which residual information is not coded, also utilizes the same merging candidate list construction process as used for merge mode. Accordingly, the merging candidate list construction techniques described herein may be applicable or a merge mode, a skip mode, or generally a merge/skip motion information prediction mode, which may be a merge mode and/or a skip mode.

In the merge and/or skip motion information prediction mode, both a video encoder and a video decoder construct a merging list of motion information candidates for a current video block (e.g., candidate motion parameters, such as reference pictures and motion vectors, for coding the current video block). The candidates in the list may include spatial merging candidates (SMCs) derived from the motion information of spatial neighboring blocks, and a temporal merging candidate (TMC) derived from the motion information of a temporal neighboring block (from a reference picture at a different time instance than the current picture of the current video block). In the case of a multiview or 3D video sequence, the merging candidate list may also include an IVMC derived from a block in different view than (but the same access unit as) the current view that includes the current video block. The candidates in the merging candidate list may also include combined bi-predictive merging candidates, and zero motion vector merging candidates. A video encoder signals the chosen motion information used to encode the current video block (i.e., the chosen candidate from the merging candidate list) by signaling an index into the candidate list. For the merge mode, once a video decoder decodes the index into the candidate list, all motion parameters of the indicated candidate are inherited by the current video block, and may be used by the video decoder to decode the current video block.

The proposed 3D-HEVC standard provides for motion information prediction according to a merge mode and/or skip mode to code video blocks. The merging candidate list construction process proposed for 3D-HEVC includes derivation and insertion of an IVMC, if available, into the merging candidate list. The merging candidate list construction process proposed for 3D-HEVC also includes constrained pruning to exclude some SMCs from the merging candidate list if they are redundant over, e.g., have the same motion information as, other SMCs. However, the merging candidate list construction process proposed for 3D-HEVC does not include the IVMC in the pruning process, e.g., does not compare the motion information of the IVMC to any other of the merging candidates, or exclude any merging candidates from list based on the IVMC having the same motion information as another merging candidate.

Accordingly, there may be problems associated with the merging candidate list construction process proposed for 3D-HEVC. For example, the merging candidate list may include an IVMC and one or more other merging candidates identical to the IVMC. Additionally, because a merging candidate list according to 3D-HEVC includes a fixed, maximum number of merging candidates, which may be less than the number of potential merging candidates that could be included in the list, redundant candidates may prevent other candidates, different from any candidate already in the list, from being derived and inserted into the merging candidate list.

The techniques described herein may include an inter-view pruning (IVP) process that includes pruning one or more merging candidates from the merging candidate list based on redundancy between the IVMC and other merging candidates. In some examples, the IVP process may include comparing the motion information of the IVMC to one or more SMCs. If the motion information of an SMC is the same as the motion information of the IVMC, the IVP process may include pruning the merging candidate list to exclude one of the merging candidates, e.g., the SMC. In some examples, the IVP process may include comparing the motion information of the IVMC to the motion information of a TMC. If the motion information of the TMC is the same as the motion information of the IVMC, the IVP process may include pruning the merging candidate list to exclude one of the merging candidates, e.g., the TMC. The example techniques of this disclosure may reduce the likelihood of redundant merging candidates in the merging candidate list. The example techniques of this disclosure may also increase the likelihood that additional, novel merging candidates, such as an additional SMC, combined bi-predictive merging candidates, or zero motion vector candidates, are included in the merging candidate list.

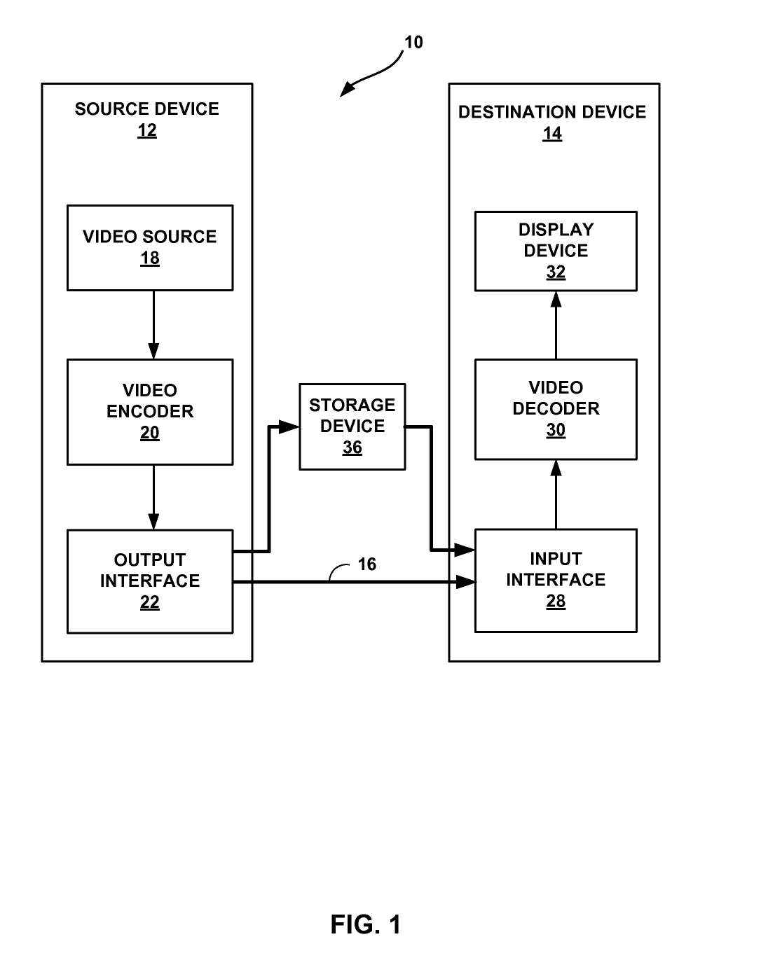

FIG. 1 is a block diagram illustrating an example encoding and decoding system 10 that may be configured to utilize the techniques described in this disclosure for constructing a merging candidate list for coding video data according to a merge mode and/or a skip mode. As used described herein, the term “video coder” refers generically to both video encoders and video decoders. In this disclosure, the terms “video coding” or “coding” may refer generically to video encoding and video decoding.

As shown in the example of FIG. 1, system 10 includes a source device 12 that generates encoded video for decoding by destination device 14. Source device 12 generates encoded video data. Accordingly, source device 12 may be referred to as a video encoding device. Destination device 14 may decode the encoded video data generated by source device 12. Accordingly, destination device 14 may be referred to as a video decoding device. Source device 12 and destination device 14 may be examples of video coding devices.

Source device 12 may transmit the encoded video to destination device 14 via communication channel 16, or may store the encoded video on a storage device 36, e.g., storage medium or file server, such that the encoded video may be accessed by the destination device 14 as desired. Source device 12 and destination device 14 may comprise any of a wide variety of devices, including desktop computers, notebook (i.e., laptop) computers, tablet computers, set-top boxes, telephone handsets (including cellular telephones or handsets and so-called smartphones), televisions, cameras, display devices, digital media players, video gaming consoles, or the like.

In many cases, such devices may be equipped for wireless communication. Hence, communication channel 16 may comprise a wireless channel. Additionally or alternatively, communication channel 16 may comprise a wired channel, a combination of wireless and wired channels, or any other type of communication channel or combination of communication channels suitable for transmission of encoded video data, such as a radio frequency (RF) spectrum or one or more physical transmission lines. In some examples, communication channel 16 may form part of a packet-based network, such as a local area network (LAN), a wide-area network (WAN), or a global network such as the Internet. Communication channel 16, therefore, generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

As further shown in the example of FIG. 1, source device 12 includes a video source 18, video encoder 20, and an output interface 22. Video source 18 may include a video capture device. The video capture device, by way of example, may include one or more of a video camera, a video archive containing previously captured video, a video feed interface to receive video from a video content provider, and/or a computer graphics system for generating computer graphics data as the source video. As one example, if video source 18 is a video camera, source device 12 and destination device 14 may form so-called camera phones or video phones, e.g., as in smartphones or tablet computers, or other mobile computing devices. The techniques described in this disclosure, however, are not limited to wireless applications or settings, and may be applied to non-wireless devices including video encoding and/or decoding capabilities. Source device 12 and destination device 14 are, therefore, merely examples of coding devices that can support the techniques described herein.

Video encoder 20 may encode the captured, pre-captured, or computer-generated video, as will be described in greater detail below. Video encoder 20 may output the encoded video to output interface 22, which may provide the encoded video to destination device 14 via communication channel 16. Output interface 22 may, in some examples, include a modulator/demodulator (“modem”) and/or a transmitter.

Output interface 22 may additionally or alternatively provide the captured, pre-captured, or computer-generated video that is encoded by the video encoder 20 to storage device 36 for later retrieval, decoding and consumption. Storage device 36 may include Blu-ray discs, DVDs, CD-ROMs, flash memory, or any other suitable digital storage media for storing encoded video. Destination device 14 may access the encoded video stored on the storage device, decode this encoded video to generate decoded video and playback this decoded video.

Storage device 36 may additionally or alternatively include any type of server capable of storing encoded video and transmitting that encoded video to the destination device 14. Example a file server, a web server (e.g., for a website), an FTP server, network attached storage (NAS) devices, a local disk drive, or any other type of device capable of storing encoded video data and transmitting it to a destination device. The transmission of encoded video data from storage device 36 may be a streaming transmission, a download transmission, or a combination of both. Destination device 14 may access storage device 36 in accordance with any standard data connection, including an Internet connection. This connection may include a wireless channel (e.g., a Wi-Fi connection or wireless cellular data connection), a wired connection (e.g., DSL, cable modem, etc.), a combination of both wired and wireless channels or any other type of communication channel suitable for accessing encoded video data stored on a file server.

Destination device 14, in the example of FIG. 1, includes an input interface 28 for receiving information, including coded video data, a video decoder 30, and a display device 32. The information received by input interface 28 may include a variety of syntax information generated by video encoder 20 for use by video decoder 30 in decoding the associated encoded video data. Each of video encoder 20 and video decoder 30 may form part of a respective encoder-decoder (CODEC) that is capable of encoding or decoding video data.

Display device 32 of destination device 14 represents any type of display capable of presenting video data for consumption by a viewer. Although shown as integrated with destination device 14, display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Again, FIG. 1 is merely an example, and the techniques of this disclosure may apply to video coding settings (e.g., video encoding or video decoding) that do not necessarily include any data communication between the encoding and decoding devices. In other examples, data can be retrieved from a local memory, streamed over a network, or the like. An encoding device may encode and store data to memory, and/or a decoding device may retrieve and decode data from memory. In many examples, the encoding and decoding is performed by devices that do not communicate with one another, but simply encode data to memory and/or retrieve and decode data from memory.

Video encoder 20 and video decoder 30 each may be implemented as any of a variety of suitable circuitry, such as one or more microprocessors, digital signal processors (DSPs), application specific integrated circuits (ASICs), field programmable gate arrays (FPGAs), discrete logic, hardware, or any combinations thereof. When the techniques are implemented partially in software, a device may store instructions for the software in a suitable, non-transitory computer-readable storage medium and may execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

As mentioned briefly above, video encoder 20 encodes video data. The video data may comprise one or more pictures. Each of the pictures is a still image forming part of a video. In some instances, a picture may be referred to as a video “frame.” When video encoder 20 encodes the video data, video encoder 20 may generate a bitstream. The bitstream may include a sequence of bits that form a coded representation of the video data. The bitstream may include coded pictures and associated data. A coded picture is a coded representation of a picture. To generate the bitstream, video encoder 20 may perform encoding operations on each picture in the video data.

As discussed above, the techniques described in this disclosure are generally related to 3D video coding, e.g., involving the coding of two or more texture views and/or view including texture and depth components. In some examples, 3D video coding techniques may use MVC or MVC plus depth processes, e.g., as in the 3D-HEVC standard currently under development. In some examples, the video data encoded by video encoder 20 and decoded by video decoder 30 includes two or more pictures at any given time instance, i.e., within an “access unit,” or data from which two or more pictures at any given time instance can be derived. In some examples, a device, e.g., video source 18, may generate the two or more pictures by, for example, using two or more spatially offset cameras, or other video capture devices, to capture a common scene. Two pictures of the same scene captured simultaneously, or nearly simultaneously, from slightly different horizontal positions can be used to produce a three-dimensional effect. Alternatively, video source 18 (or another component of source device 12) may use depth information or disparity information to generate a second picture of a second view at a given time instance from a first picture of a first view at the given time instance. In this case, a view within an access unit may include a texture component corresponding to a first view and a depth component that can be used, with the texture component, to generate a second view. The depth or disparity information may be determined by a video capture device capturing the first view, or may be calculated, e.g., by video source 18 or another component of source device 12, from video data in the first view.

To present 3D video, display device 32 may simultaneously, or nearly simultaneously, display two pictures associated with different views of a common scene, which were captured simultaneously or nearly simultaneously. In some examples, a user of destination device 14 may wear active glasses to rapidly and alternatively shutter left and right lenses, and display device 32 may rapidly switch between a left view and a right view in synchronization with the active glasses. In other examples, display device 32 may display the two views simultaneously, and the user may wear passive glasses, e.g., with polarized lenses, which filter the views to cause the proper views to pass through to the user's eyes. In other examples, display device 32 may comprise an autostereoscopic display, which does not require glasses for the user to perceive the 3D effect.

Video encoder 20 and video decoder 30 may operate according to any of the video coding standards referred to herein, such as the HEVC standard and the 3D-HEVC extension presently under development. When operating according to the HEVC standard, video encoder 20 and video decoder 30 may conform to the HEVC Test Model (HM). The techniques of this disclosure, however, are not limited to any particular coding standard.

HM refers to a block of video data as a coding unit (CU). In general, a CU has a similar purpose to a macroblock coded according to H.264, except that a CU does not have the size distinction associated with the macroblocks of H.264. Thus, a CU may be split into sub-CUs. In general, references in this disclosure to a CU may refer to a largest coding unit (LCU) of a picture or a sub-CU of an LCU. For example, syntax data within a bitstream may define the LCU, which is a largest coding unit in terms of the number of pixels. An LCU may be split into sub-CUs, and each sub-CU may be split into sub-CUs. Syntax data within a bitstream may define a maximum number of times an LCU may be split, referred to as a maximum CU depth. Accordingly, a bitstream may also define a smallest coding unit (SCU).

An LCU may be associated with a hierarchical quadtree data structure. In general, a quadtree data structure includes one node per CU, where a root node corresponds to the LCU. If a CU is split into four sub-CUs, the node corresponding to the CU includes a reference for each of four nodes that correspond to the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs.

A When video encoder 20 encodes a non-partitioned CU, video encoder 20 may generate one or more prediction units (PUs) for the CU. Each of the PUs of the CU may be associated with a different video block within the video block of the CU. Video encoder 20 may generate a predicted video block for each PU of the CU. The predicted video block of a PU may be a block of samples. Video encoder 20 may use intra prediction or inter prediction to generate the predicted video block for a PU.

In general, a PU represents all or a portion of the corresponding CU, and includes data for coding the block of video data associated with the PU. For example, the PU may include data indicating a prediction mode for coding the associated block of video data, e.g., whether the block is intra-coded or inter-coded. An intra-coded block is coded based on an already-coded block in the same picture. An inter-coded block is coded based on an already-coded block of a different picture. The different picture may be a temporally different picture, i.e., a picture before or after the current picture in a video sequence. Alternatively, in the case of multiview coding, e.g., in 3D-HEVC, the different picture may be a picture that is from the same access unit as the current picture, but associated with a different view than the current picture. In this case, the inter-prediction can be referred to as inter-view coding.

The block of the different picture used for predicting the block of the current picture is identified by a prediction vector. In multiview coding, there are two kinds of prediction vectors. One is a temporal motion vector pointing to a block in a temporal reference picture. The other type of prediction vector is a disparity motion vector, which points to a block in a picture in the same access unit current picture, but of a different view. With a disparity motion vector, the corresponding inter prediction is referred to as disparity-compensated prediction (DCP).

The data defining a motion vector or disparity motion vector may describe, for example, a horizontal component of the motion vector, a vertical component of the motion vector, and a resolution for the motion vector (e.g., integer precision, one-quarter pixel precision or one-eighth pixel precision). The data for the PU may also include data indicating a direction of prediction, i.e., to identify which of reference picture lists L0 and L1 should be used. The data for the PU may also include data indicating a reference picture to which the motion vector or disparity motion vector points, e.g., a reference picture index into a list of reference pictures. Data for the CU defining the PU(s) may also describe, for example, partitioning of the CU into one or more PUs. Partitioning modes may differ between whether the CU is uncoded, intra-prediction mode encoded, or inter-prediction mode encoded.

In addition to having one or more PUs, a CU may include one or more transform units (TUs). Following prediction using a PU, a video encoder may calculate residual values for the portion of the CU corresponding to the PU, where these residual values may also be referred to as residual data. The residual values may comprise pixel difference values, e.g., differences between coded pixels and predictive pixels, where the coded pixels may be associated with a block of pixels to be coded, and the predictive pixels may be associated with one or more blocks of pixels used to predict the coded block. A TU is not necessarily limited to the size of a PU. Thus, TUs may be larger or smaller than corresponding PUs for the same CU. In some examples, the maximum size of a TU may be the size of the corresponding CU. This disclosure uses the term “block” or “video block” to refer to any one or combination of a CU, PU, and/or TU.

To further compress the residual values of a block, the residual values may be transformed into a set of transform coefficients that compact data (also referred to as “energy”) as possible into coefficients. Transform techniques may comprise a discrete cosine transform (DCT) process or conceptually similar process, integer transforms, wavelet transforms, or other types of transforms. The transform converts the residual values of the pixels from the spatial domain to a transform domain. The transform coefficients correspond to a two-dimensional matrix of coefficients that is ordinarily the same size as the original block. In other words, there are just as many transform coefficients as pixels in the original block. However, due to the transform, many of the transform coefficients may have values equal to zero.

Video encoder 20 may then quantize the values of the transform coefficients to further compress the video data. Quantization generally involves mapping values within a relatively large range to values in a relatively small range, thus reducing the amount of data needed to represent the quantized transform coefficients. The quantization process may reduce the bit depth associated with some or all of the coefficients.

Following quantization, video encoder 20 may scan the transform coefficients, producing a one-dimensional vector from the two-dimensional matrix including the quantized transform coefficients. Video encoder 20 may then entropy encode the one-dimensional vector to even further compress the data. In general, entropy coding comprises one or more processes that collectively compress a sequence of quantized transform coefficients and/or other syntax information. Entropy coding may include, as examples, content adaptive variable length coding (CAVLC), context adaptive binary arithmetic coding (CABAC), syntax-based context-adaptive binary arithmetic coding (SBAC), Probability Interval Partitioning Entropy (PIPE) coding, or another entropy encoding methodology.

In addition, video encoder 20 may decode encoded pictures, e.g., by inverse quantizing and inverse transforming residual data, and combine the residual data with prediction data. In this manner, video encoder 20 can simulate the decoding process performed by video decoder 30. Both video encoder 20 and video decoder 30, therefore, will have access to substantially the same decoded pictures for use in inter-picture prediction.

In general, video decoder 30 may perform a decoding process that is the inverse of the encoding process performed by video encoder. For example, video decoder 30 may perform entropy decoding using the inverse of the entropy encoding techniques used by video encoder to entropy encode the quantized video data. Video decoder 30 may further inverse quantize the video data using the inverse of the quantization techniques employed by video encoder 20, and may perform an inverse of the transformation used by video encoder 20 to produce the transform coefficients that quantized. Video decoder 30 may then apply the resulting residual blocks to adjacent reference blocks (intra-prediction) or reference blocks from another picture (inter-prediction) to produce the video block for eventual display. Video decoder 30 may be configured, instructed, controlled or directed to perform the inverse of the various processes performed by video encoder 20 based on the syntax elements provided by video encoder 20 with the encoded video data in the bitstream received by video decoder 30.

As discussed above, the data defining a motion vector or disparity motion vector for a block of video data may include horizontal and vertical components of the vector, as well as a resolution for the vector. Motion information for a video block, e.g., PU, may include a motion vector, as well as a prediction direction and a reference picture index value. Additionally, as discussed above, the motion information for a current video block may be predicted from the motion information of a neighboring video block, e.g., PU, which may also be referred to as a reference block. The reference block may be a spatial neighbor within the same picture, a temporal neighbor within a different picture of the same view, but within a different access unit, or a video block within a different picture of a different view, but within the same access unit. In the case of motion information from a reference block in a different view, the motion vector may be a temporal motion vector derived from a reference block in an interview reference picture (i.e., a reference picture in the same access unit as the current picture, but from a different view), or a disparity motion vector derived from a disparity vector.

Typically, for motion information prediction, a list of candidate motion information from various reference blocks is formed in a defined manner, e.g., such that the motion information from various reference blocks are considered for inclusion in the list in a defined order. After forming the candidate list, video encoder 20 may assess each candidate to determine which provides the best rate and distortion characteristics that best match a given rate and distortion profile selected for encoding the video. Video encoder 20 may perform a rate-distortion optimization (RDO) procedure with respect to each of the candidates, selecting the one of the motion information candidates having the best RDO results. Alternatively, video encoder 20 may select one of the candidates stored in the list that best approximates the motion information determined for the current video block.

In any event, video encoder 20 may specify the selected candidate using an index identifying the selected one of the candidates in the candidate list of motion information. Video encoder 20 may signal this index in the encoded bitstream for use by video decoder 30. For coding efficiency, the candidates may be ordered in the list such that the candidate motion information most likely to be selected for coding the current video block is first, or otherwise is associated with the lowest magnitude index value.

Techniques for motion information prediction may include a merge mode, skip mode, and an advance motion vector prediction (AMVP) mode. In general, according to merge mode and/or skip mode, a current video block, e.g., PU, inherits the motion information, e.g., motion vector, prediction direction, and reference picture index, from another, previously-coded neighboring block, e.g., a spatially-neighboring block in the same picture, or a block in a temporal or interview reference picture. When implementing the merge/skip mode, video encoder 20 constructs a list of merging candidates that are the motion information of the reference blocks in a defined matter, selects one of the merging candidates, and signals a candidate list index identifying the selected merging candidate to video decoder 30 in the bitstream.

Video decoder 30, in implementing the merge/skip mode, receives this candidate list index, reconstructs the merging candidate list according to the defined manner, and selects the one of the merging candidates in the candidate list indicated by the index. Video decoder 30 may then instantiates the selected one of the merging candidates as a motion vector for the current PU at the same resolution as the motion vector of the selected one of the merging candidates, and pointing to the same reference picture as the motion vector for the selected one of the merging candidates. Accordingly, at the decoder side, once the candidate list index is decoded, all of the motion information of the corresponding block of the selected candidate may be inherited such as, e.g., motion vector, prediction direction, and reference picture index. Merge mode and skip mode promote bitstream efficiency by allowing the video encoder 20 to signal an index into the merging candidate list, rather than all of the motion information for inter-prediction of the current video block.

When implementing AMVP, video encoder 20 constructs a list of candidate motion vector predictors (MVPs) in a defined matter, selects one of the candidate MVPs, and signals a candidate list index identifying the selected MVP to video decoder 30 in the bitstream. Similar to merge mode, when implementing AMVP, video decoder 30 reconstructs the list of candidate MVPs in the defined matter, decodes the candidate list index from the encoder, and selects and instantiates one of the MVPs based on candidate list index.

However, contrary to the merge/skip mode, when implementing AMVP, video encoder 20 also signals a reference picture index and prediction direction, thus specifying the reference picture to which the MVP specified by the candidate list index points. Further, video encoder 20 determines a motion vector difference (MVD) for the current block, where the MVD is a difference between the MVP and the actual motion vector that would otherwise be used for the current block. For AMVP, in addition to the reference picture index, reference picture direction and candidate list index, video encoder 20 signals the MVD for the current block in the bitstream. Due to the signaling of the reference picture index and prediction vector difference for a given block, AMVP may not be as efficient as merge/skip mode, but may provide improved fidelity of the coded video data.

In general, the techniques described herein are described as being implemented in the context of coding a video block according to a merge mode and/or a skip mode. However, the techniques described herein may, in some examples, be applied in coding a video block using any motion information prediction mode.

To provide even more efficient motion information prediction, the defined manner for constructing a merging candidate list employed by video encoder 20 and video decoder 30 may include “pruning,” e.g., removing or otherwise excluding, redundant merging candidates from the list for a current video block. In some examples, merging candidates that include motion vectors having the same amplitude on both the X and Y components, and referencing the same reference picture, e.g., identical merging candidates, may be considered as redundant merging candidates. Pruning may occur by removing one or more merging candidates from the list, and/or by not adding one more identified merging candidates to the list, in various examples. In either case, the pruning process may reduce the size of the list and/or allow additional merging candidates to be included in a list with a fixed maximum size.

The fixed maximum length for the merging candidate list may be determined and signaled by video encoder 20, and may be, as examples, 5 or 6 merging candidates. If, after pruning, the merging candidate list is greater than the maximum length, the video coder (e.g., video encoder 20 or video decoder 30) may truncate the merging candidate list. Accordingly, the order of derivation and inclusion of merging candidates in the candidate list may be significant as one or more merging candidates at the end of the list may be more likely to be truncated.

If, after pruning, the merging candidate list is less than the maximum length, the video coder may add additional merging candidates, such as combined bi-predictive candidates, or zero motion vector candidates. Zero motion vector candidates include motion vectors whose X and Y values are 0. The merging candidate list may also have fewer than the maximum number of entries of one or more possible merging candidates for the current video block were not available for inclusion in the merging candidate list. Merging candidates may be unavailable when, for example, the spatially-neighboring, temporal, or interview reference blocks were intra-coded. As another example, spatial MVCs may be unavailable when the spatially-neighboring blocks are unavailable due to the position of the current block relative to a picture or slice boundary.

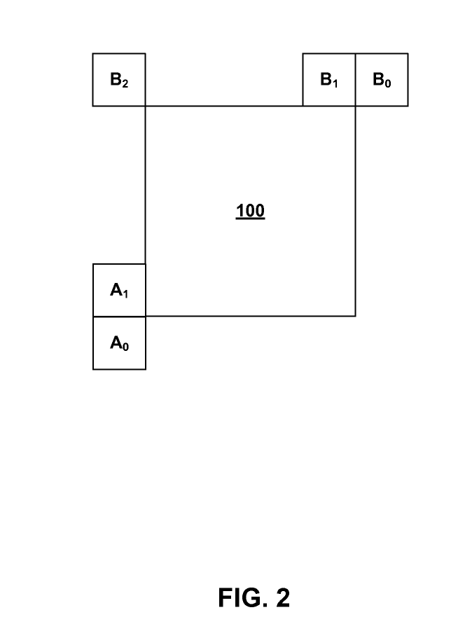

FIG. 2 is a conceptual diagram illustrating an example current video block 100, in relation to a plurality of spatially-neighboring, e.g., adjacent, blocks A₁, B₁, B₀, A₀, and B₂ from which spatial merging candidates (SMCs) for the current block may be derived. In some examples, current video block 100 and reference video blocks A₁, B₁, B₀, A₀, and B₂ may be PUs, as generally defined in the HEVC standard currently under development.

As illustrated in FIG. 2, video blocks A₁, B₁, B₀, A₀, and B₂ may be left, above, above-right, below-left, and above-left, respectively, relative to the current video block. However, the number and locations of neighboring blocks A₁, B₁, B₀, A₀, and B₂ relative to current video block 100 illustrated in FIG. 2 are merely examples. In other locations, the motion information of a different number of neighboring blocks and/or of blocks at different locations, may be considered as SMCs for inclusion in a merging candidate list for video block 100.

The spatial relationship of each of spatially-neighboring blocks A₁, B₁, B₀, A₀, and B₂ to current block 100 may be described as follows. A luma location (xP, yP) is used to specify the top-left luma sample of the current block relative to the top-left sample of the current picture. Variables nPSW and nPSH denote the width and the height of the current block for luma. The top-left luma sample of spatially-neighboring block A₁ is xP−1, yP+nPSH−1. The top-left luma sample of spatially-neighboring block B₁ is xP+nPSW−1, yP−1. The top-left luma sample of spatially-neighboring block B₀ is xP+nPSW, yP−1. The top-left luma sample of spatially-neighboring block A₀ is xP−1, yP+nPSH. The top-left luma sample of spatially-neighboring block B₂ is xP−1, yP−1. Although described with respect to luma locations, the current and reference blocks may include chroma components.

Each of spatially-neighboring blocks A₁, B₁, B₀, A₀, and B₂ may provide an SMC for block 100. When one of these spatially-neighboring blocks provides an SMC for block 100, the block may be referred to as an “SMC” block, e.g., “A₀ SMC,” “A₁ SMC,” and so forth. A video coder, e.g., video encoder 20 (FIG. 1) or video decoder 30 (FIG. 1), may consider the motion information of the spatially-neighboring reference blocks in a predetermined order, e.g., a scan order. In the case of 3D-HEVC, for example, the video decoder may consider the motion information of the reference blocks for inclusion in the merging candidate list as SMCs in the following order: A₁, B₁, B₀, A₀, and B₂. In some examples, e.g., according to the merging candidate list construction process proposed for 3D-HEVC, the video coder may consider and include SMCs in the merging candidate list, with constrained pruning among the SMCs, according to the following process.
1. Insert A₁ SMC into the candidate list, if available.
2. If B₁ and A₁ SMCs have the same motion vectors and the same reference indices, B₁ is not inserted into the candidate list. Otherwise, insert B₁ SMC into the candidate list, if available. If B₀ and B₁ SMCs have the same motion vectors and the same reference indices, B₀ SMC is not inserted into the candidate list. Otherwise, insert B₀ SMC into the candidate list, if available.
3. If A₀ and A₁ SMCs have the same motion vectors and the same reference indices, A₀ is not inserted into the candidate list. Otherwise, insert A₀ SMC into the candidate list, if available.
4. B₂ SMC is inserted into the candidate list when both of the following conditions are not satisfied:
   a. B₂ and B_{1 or B}₂ and A₁ SMCs have the same motion vectors and the same reference indices.
   b. All of the four SMCs derived from A₁, B₁, B₀, A₀ and an IVMC are included in the candidate list. For HEVC, rather than 3D-HEVC, this condition is based on A₁, B₁, B₀, and A₀, rather than A₁, B₁, B₀, A₀ and an IVMC.

In the illustrated example, spatially-neighboring blocks A₁, B₁, B₀, A₀, and B₂ are to the left of and/or above, block 100. This arrangement is typical, as most video coders code video blocks in raster scan order from the top-left of a picture. Accordingly, in such examples, spatially-neighboring blocks A₁, B₁, B₀, A₀, and B₂ will typically be coded prior to current block 100. However, in other examples, e.g., when a video coder codes video blocks in a different order, spatially-neighboring blocks A₁, B₁, B₀, A₀, and B₂ may be located to the right of and/or below current block 100.

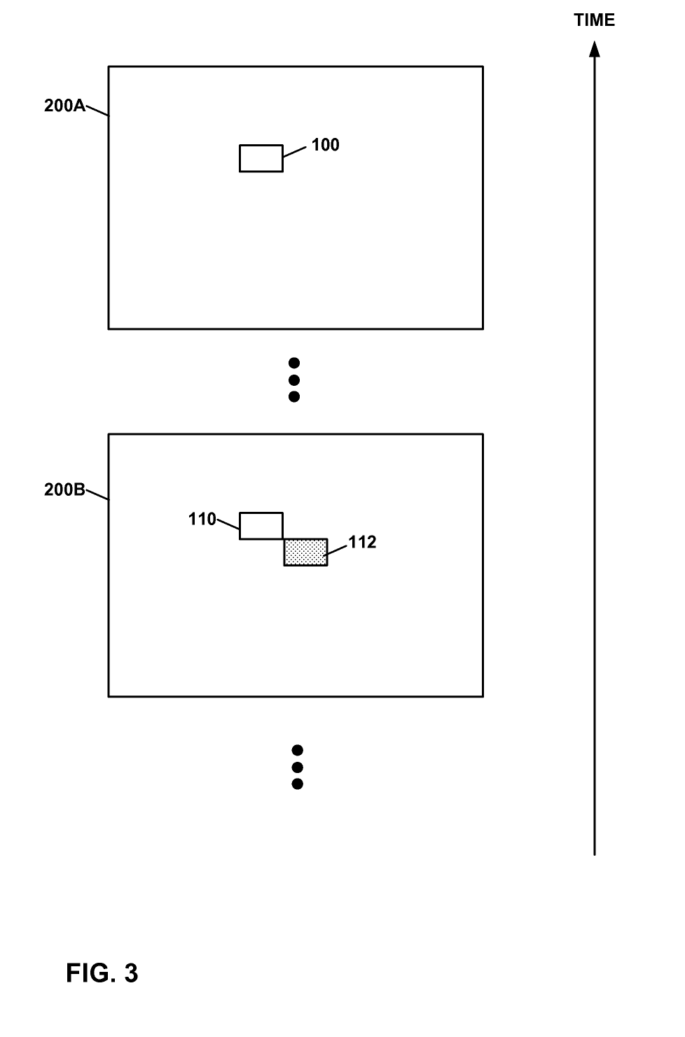

FIG. 3 is a conceptual diagram illustrating an example picture 200A including a current video block 100, and a temporal reference picture 200B, within a video sequence. Temporal reference picture 200B is a picture coded prior to picture 200A. Temporal reference picture 200B is not necessarily the immediately prior picture, in time, to picture 200A. Additionally, while temporal reference picture 200B is prior to picture 200A in coding order, the reference picture is not necessarily prior to picture 200A in display order. A video coder may select temporal reference picture 200B from among a plurality of possible temporal reference pictures, and a reference picture index value may indicate which of the temporal reference pictures to select.

Temporal reference picture 200B includes a co-located block 110, which is co-located in picture 200B relative to the location of current block 100 in picture 200A. Temporal reference picture 200B also includes a temporal reference block 112 for current block 100 in picture 200A. A coder may derive a TMC for current block 100 to include the motion information of reference block 112. Temporal reference block 112 is a spatially-neighboring block to co-located block 110. In the illustrated example, reference block 112 is located to the right of and below co-located block 110. In some examples, reference block may be a right-bottom PU of the co-located PU, e.g., co-located block 110. A proposed technique for a video coder to derive a TMC for a current video block according to proposals for merge mode in 3D-HEVC is as follows.
1. A co-located picture is identified. If the current picture is a B slice, a collocated_from_{—}10 flag is signaled in slice header to indicate whether the co-located picture is from RefPicList0 or RefPicList1 .
2. After a reference picture list is identified, collocated_ref_idx, signaled in slice header, is used to identify the picture in the picture in the list.
3. A co-located PU is then identified by checking the co-located picture. Either the motion of the right-bottom PU of the CU containing this PU, or the motion of the right-bottom PU within the center PUs of the CU containing this PU is used.
4. When motion vectors identified by the above process are used to generate a motion candidate for merge mode, they may need to be scaled based on the temporal location (reflected by POC).
5. In HEVC and 3D-HEVC, the picture parameter set (PPS) includes a flag enable_temporal_mvp_flag. When a particular picture with temporal_id equal to 0 refers to a PPS having enable_temporal_mvp_flag equal to 0, all the reference pictures in the reference picture memory or decoded picture buffer (DPB) are marked as “unused for temporal motion vector prediction,” and no motion vector from pictures before that particular picture in decoding order would be used as a temporal motion vector predictor in decoding of the particular picture or a picture after the particular picture in decoding order.

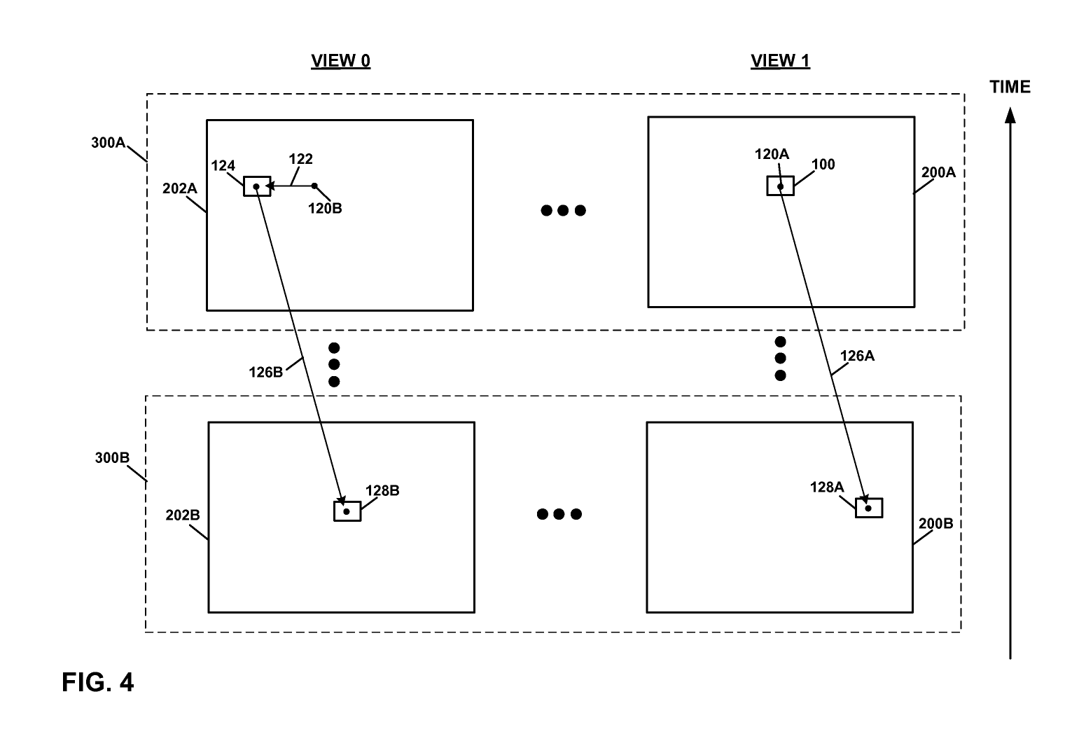

FIG. 4 is a conceptual diagram illustrating pictures of a plurality of access units, each access unit including a plurality of views. In particular, FIG. 4 illustrates access units 300A and 300B, each of which may represent a different point in time in a video sequence. Although two access units 300A and 300B are illustrated, the video data may include many additional access units, both forward and backward in the sequence relative to access unit 300A, and access units 300A and 300B need not be adjacent or consecutive access units.

The video data including access units 300A and 300B is multiview video data, i.e., includes multiple views of a common scene, and may, in some examples, be MVC plus depth data, where each view includes a texture component and a depth component. FIG. 4 illustrates pictures of two views, VIEW 0 and VIEW 1. The video data may include additional views not shown in FIG. 4.

Access unit 300A includes picture 200A of VIEW 1. Picture 200A includes current block 100. Access unit 300A may be referred to as the current access unit, VIEW 1 may be referred to as the current view, and picture 200A may be referred to as the current picture. Access unit 300A also includes picture 202A of VIEW 0. VIEW 0 may be referred to as a reference view, and picture 202A may be referred to as an inter-view reference picture. Access unit 300B includes picture 200B of VIEW 1, and picture 202B of VIEW 0. Picture 200B of VIEW 1 may be referred to as a temporal reference picture for picture 200A.

One of the most efficient coding tools in 3D-HEVC is inter-view motion prediction (IMP) where the motion information of a block in a dependent view are predicted or inferred based on already coded motion parameters in another view, i.e., a reference view, of the same access unit. In addition, the IVMC candidate may be the motion information converted from a disparity vector. To include the inter-view motion prediction, the merge mode for 3D-HEVC has been extended in a way that an IVMC (inter-view merging candidate) is added to the candidate list of merging candidates for a block to be coded.

To derive an IVMC for a current video block, a video coder, for each potential motion hypothesis, may investigate the first two reference picture indices of the reference picture list in the given order. The IVMC may be derived for each of reference picture in the manner described below with respect to reference picture 202A. If the derived motion vector is valid, the reference index 0 and the derived motion vector are used for the considered hypothesis. Otherwise, the reference index 1 is tested in the same way. If it also results in an invalid motion vector, the motion hypothesis is marked as not available. In order to prefer temporal prediction, the order in which is reference indices are tested is reversed if the first index refers to an inter-view reference picture. If all potential motion hypotheses are marked as not available, the IVMC cannot be selected, and is unavailable.

To derive an IVMC for current block 100, a video coder identifies a sample 120A in block 100, and a co-located sample 120B in inter-view reference picture 202A. Again, reference picture 202A may be identified based on one of the first two indices in either of the reference picture lists per the technique described above. Based on disparity information for picture 200A relative to inter-view reference picture 202A, the coder determines a disparity vector 122. The disparity information could be derived from a depth map or other depth information for picture 200A. Based on disparity vector 122, the coder identifies a reference block 124 in inter-view reference picture 202A of the reference view (VIEW 0).

If the reference picture index for current block 100 in RefPicListX (wherein X could be 0 or 1), e.g., according to the technique where the first two indices of each motion hypothesis are tested, refers to inter-view reference picture 202A, the coder sets the IVMC candidate for current block 100 equal to disparity vector 122, which then becomes a so-called disparity motion vector for block 100. In particular, the disparity motion vector points to the block 124 in picture 202A as a reference block for prediction of block 100A in picture 200A. In one example, the vertical component of the disparity motion vector may be forced to be 0.

If the reference picture index for current block 100 in RefPicListX (wherein X could be 0 or 1) refers to temporal reference picture 200B in access unit 300B, the coder determines whether reference block 124 was coded based on a motion vector that referred to the same access unit 300B as the current reference index. In the example illustrated by FIG. 4, reference block 124 was coded based on a motion vector 126B either in RefPicListX or RefPicListY (where Y is equal to 1-X) that points to a block 128B in picture 202B in access unit 300B. In such cases, the coder sets the IVMC candidate for current block 100 equal to a motion vector 126A that points to a temporal reference block 128A in temporal reference picture 200B of VIEW 1. Motion vector 126A corresponds to motion vector 126B, e.g., the horizontal and vertical components of the motion vectors are the same, but motion vectors 126A and 126B refer to different pictures associated with different views in the same access unit. In some examples, if the motion vector of reference block 124 points to a different access unit then the reference picture index for current block 100, the coder may consider IVMC candidate unavailable for current block 100. Accordingly, when the reference block has a reference picture either in List 0 or List 1 in the same access unit as the reference picture of the current block with the current reference index in the current reference picture list, the corresponding motion information is treated as available.

A variety of techniques may be used to derive disparity vectors, such as disparity vector 122. In some examples, video for one or more views is coded dependent of depth data, and the video coder uses the coded depth map(s) to derive disparity vectors. In other examples, where video is coded independently of depth data, a video coder may derive disparity vectors based on coded motion vectors and disparity motion vectors. This approach can also be used for video only, but such an approach increases the complexity greatly, especially at the decoder side. In co-pending and commonly-assigned U.S. patent application Ser. No. 13/802,344, a disparity vector construction method from Spatial Disparity Vectors (SDV), Temporal Disparity Vectors (TDV) or Implicit Disparity Vectors (IDV) is proposed for inter-view motion prediction. The entire content of this application is incorporated herein by reference.

The merging candidate list construction process proposed for HEVC is as follows:
1. Derive and insert SMCs into the merging candidate list, e.g., as described above with respect to FIG. 2 (with B₂ SMC being derived and inserted when different than B₁ and A₁ SMCs, and less than all of A₁, B₁, B₀, and A₀ SMCs are already included in the merging candidate list).
2. Derive and insert TMC into the merging candidate list, e.g., as described above with respect to FIG. 3.
3. If the current slice is a B slice, and the total number of candidates derived from the above steps is less than the predetermined maximum number of candidates and greater than 1, derive and insert one or more combined bi-predictive candidates. Based on the Table 1, to generate a combined bi-predictive candidate with index combIdx, the RefList0 motion information (MotList0) of the candidate list with entry equal to 10CandIdx, if available, and the RefList1 motion information (MotList1) of the candidate list with entry equal to 11CandIdx, if available and not identical to MotList0, are re-used as the RefList0 and RefList1 motion information of the combined bi-predictive candidate.
4. If the total number of candidates derived from the above steps is less than the maximum number of candidates, insert one or more zero motion vectors, e.g., a zero motion vector for each reference picture, into the candidate list.

TABLE 1
Specification of l0CandIdx and l1CandIdx in HEVC

| combIdx | 0 | 1 | 2 | 3 | 4 | 5 | 6 | 7 | 8 | 9 | 10 | 11 |
|---|---|---|---|---|---|---|---|---|---|---|---|---|
| l0CandIdx | 0 | 1 | 0 | 2 | 1 | 2 | 0 | 3 | 1 | 3 | 2 | 3 |
| l1CandIdx | 1 | 0 | 2 | 0 | 2 | 1 | 3 | 0 | 3 | 1 | 3 | 2 |

In a recent HEVC draft, the total number of candidates in the merging candidate list is up to 5. Video encoder 20 signals five_minus_max_num_merge_cand in slice header to specify the maximum number of the MRG candidates subtracted from 5.

The merging candidate list construction process proposed for 3D-HEVC is as follows:
1. Derive and insert IVMC into merging candidate list, e.g., as described above with respect to FIG. 4.
2. Derive and insert SMCs into the merging candidate list, e.g., as described above with respect to FIG. 2 (with B₂ being derived and inserted when different than B₁ and A₁ SMCs, and less than all of A₁, B₁, B₀, A₀ SMCs and an IVMC are already included in the merging candidate list).
3. Derive and insert TMC into the merging candidate list, e.g., as described above with respect to FIG. 3.
4. If the current slice is a B slice, and the total number of candidates derived from the above steps is less than the predetermined maximum number of candidates and greater than 1, derive and insert one or more combined bi-predictive candidates. Based on the Table 2, to generate a combined bi-predictive candidate with index combIdx, the RefList0 motion information (MotList0) of the candidate list with entry equal to 10CandIdx, if available, and the RefList1 motion information (MotList1) of the candidate list with entry equal to 11CandIdx, if available and not identical to MotList0, are re-used as the RefList0 and RefList1 motion information of the combined bi-predictive candidate.
5. If the total number of candidates derived from the above steps is less than the maximum number of candidates, insert one or more zero motion vectors, e.g., a zero motion vector for each reference picture, into the candidate list

TABLE 2
Specification of l0CandIdx and l1CandIdx for 3D-HEVC

| combIdx | 0 | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|---|
| l0CandIdx | 0 | 1 | 0 | 2 | 1 | 2 | 0 | 3 | 1 | 3 | 2 | 3 | 0 | 4 | 1 | 4 | 2 | 4 | 3 | 4 |
| l1CandIdx | 1 | 0 | 2 | 0 | 2 | 1 | 3 | 0 | 3 | 1 | 3 | 2 | 4 | 0 | 4 | 1 | 4 | 2 | 4 | 3 |

According to proposals for 3D-HEVC, the total maximum number of candidates in the merging candidate list is up to 6. Video encoder 20 may signal five_minus_max_num_merge_cand in the slice header to specify the maximum number of merging candidates in the list subtracted from 6. The value of five_minus_max_num_merge_cand is in the range of 0 to 5, inclusive.

There may be problems with the proposed merging candidate list construction process for 3D-HEVC. For example, identical candidates may be present in the final candidate list (which, according to the 3D-HEVC specification, always contains fixed number of entries), even when there is a possible candidate which is different from any candidate in the final candidate list. For example, when five_minus_max_num_merge_cand is set to 0, and the IVMC has the same motion vectors and reference indices with one of the SMCs, if all the merging candidates derived from A₁, B₁, B₀ and A₀ and IVMC are available, regardless of the motion information of B₂, the final list may not include the merging candidate from B₂. Additionally, when five_minus_max_num_merge_cand is set to 0, and the IVMC has the same motion vectors and reference indices with the TMC, if four SMCs, one TMC and the IVMC are available, the final list may not include any combined bi-predictive merging candidates or zero motion vector merging candidates.

This disclosure describes techniques related to merging candidate list pruning for multiview coding, e.g., for 3D-HEVC. The techniques described herein may include an inter-view pruning (IVP) process that includes pruning one or more merging candidates from the merging candidate list based on redundancy between the IVMC and other merging candidates. In some examples, the IVP process may include comparing the motion information of the IVMC to one or more SMCs. If the motion information of an SMC is the same as the motion information of the IVMC, the IVP process may include pruning the merging candidate list to exclude one of the merging candidates, e.g., the SMC. In some examples, the IVP process may include comparing the motion information of the IVMC to the motion information of a TMC. If the motion information of the TMC is the same as the motion information of the IVMC, the IVP process may include pruning the merging candidate list to exclude one of the merging candidates, e.g., the TMC.

According to the techniques of this disclosure, when an IVMC is the same as any potential spatial or temporal merging candidate, the IVMC duplication is not present in the final merging candidate list and at least one more additional candidate which is not IVMC duplication can be present in the final merging candidate list. Thus, the example techniques of this disclosure may reduce the likelihood of redundant merging candidates in the merging candidate list. The example techniques of this disclosure may also increase the likelihood that additional, novel merging candidates, such as the B₂ SMC, combined bi-predictive merging candidates, or zero motion vector candidates, are included in the merging candidate list. Various example merging candidate list construction processes according to this disclosure are as follows.

### EXAMPLE #1

A video coder invokes the IVMC derivation and insertion process, the derivation process for SMCs, and the TMC derivation process as proposed for 3D-HEVC, e.g., as described above. The number of merging candidates represented by the IVMC and SMCs in the merging candidate list is denoted by K. If B₂ SMC available, K is equal to 5 (or the number of SMCs is equal to 4), the IVMC is equal to one of the existing SMCs, and B₂ SMC is unequal to any of the SMCs in the merging list, the video coder inserts the B₂ SMC into the merging candidate list. The video coder may insert the B₂ SMC into the merging candidate list to follow all other SMCs, but to precede the TMC, if a TMC is available, or insert the B₂ SMC after the other SMCs and TMC, but before all the other merging candidates.

The video coder may then apply an IVP process if an IVMC was available. After the IVP process, if the length of the list is more than N, the video coder truncates the list to contain only N entries. The IVP process may be applied to one or more of the derived SMCs, each of the derived SMCs, the TMC, or the TMC and one or more of the SMCs. The video coder may apply the IVP process after derivation and insertion of the TMC, or before derivation and insertion of the TMC.

In any case, the video coder compares the motion information of the one or more other merging candidates to the motion information of the IVMC. If the motion information is the same, the video coder prunes the merging candidate list to exclude one of the redundant merging candidates, e.g., an SMC or TMC. For example, for each merging candidate which is either an SMC or a TMC, (thus it is not a combined bi-predictive merging candidate or zero motion vector merging candidate), if it has the same reference indices and motion vectors as with IVMC, the video coder may exclude the candidate from the merging candidate list. The video coder may shift all merging candidates that are after the pruned candidate according to an order of the list up or left in the merging candidate list by 1. In some examples in which a candidate preceding the IVMC is removed, the video coder may insert the IVMC into the position of the removed merging candidate.

If the total number of merging candidates in the list remains less than the maximum number of candidates, the video coder may derive and insert combined bi-predictive candidates into the merging candidate list, e.g., according to values of combIdx and Table 2 (or Table 1), above. If the total number of merging candidates in the list still remains less than the maximum number of candidates, the video coder may insert zero motion vectors into the merging candidate list.

Examples of implementation of the merging candidate list construction process according to the Example #1 merging candidate list construction process where I₀ denotes the IVMC, T₆ denotes the TMC, the length of the final merging candidate list is equal to 6, and the SMC from B₂, if inserted into the merging candidate list, is inserted to into the merging candidate list immediately following the other SMCs are as follows:
1. Suppose S₁, S₂, S₃, S₄, S₅ denote the SMCs from A₁, B₁, B₀, A₀ or B₂, respectively, and the video coder applies the IVP process to the TMC.
   a. If I₀ is different from Sⱼ (j is from 1 to 5) and T₆ (either the motion vectors or reference indices are different), the final merging list may be I₀, S₁, S₂, S₃, S₄ and T₆.
   b. If 1₀ is different from Sⱼ (j is from 2 to 5) and T₆, I₀ is identical to S₁, and S₅ is different than S₁, S₂, S₃ and S₄, the final merging list may be I₀, S₂, S₃, S₄, S₅ and T₆.
   c. If I₀ is different from Sⱼ (j is from 1 to 5), and I₀ is identical to T₆, the final merging list may be I₀, S₁, S₂, S₃, S₄ and one combined bi-predictive merging candidate.
2. Suppose three SMCs derived and inserted into the merging candidate list are denoted by S₁, S₂, S₃ from A₁, B₁, B₂, respectively, and the video coder does not apply the IVP process to the TMC.
   a. If I₀ is different from Sj (j is from 1 to 3), the final merging candidate list may be I₀, S₁, S₂, S₃, T₆ and one combined bi-predictive merging candidate (if available) or zero motion vector candidate.
   b. If I₀ is different from S₁ and S₂ but equal to S₃ (with the same reference indices and motion vectors), the final merging list may be I₀, S₁, S₂, T₆ and two other candidates which may be combined bi-predictive merging candidates (if available) or zero motion vector candidates.
3. Suppose four SMCs derived and inserted into the merging candidate list are denoted by S₁, S₂, S₃ and S₄ from A₁, B₁, A₀ and B₂, or A₁, B₁, A₀ and B₀ respectively, and the video coder does not apply the IVP process to the TMC.
   a. If I₀ is different from S₁ and S₂ but equal to S₃ and S₄ (with the same reference indices and motion vectors), the final merging list may be I₀, S₁, S₂, T₆ and two other candidates which may be combined bi-predictive merging candidates (if available) or zero motion vector candidates.

### EXAMPLE #2

A video coder invokes the merging candidate list derivation process proposed for HEVC, e.g., as described above. The merging candidate list construction process proposed for HEVC may include derivation and insertion of one or more combined bi-predictive merging candidates (e.g., according to a value of combIdx and Table 1, above) and zero motion vector merging candidates. The video coder then derives and inserts the IVMC, if available, into any position within the merging candidate list. The video coder then inserts the B₂ SMC into the candidate list, if it is available and not equal to any of the existing merging candidates. The video coder may, as examples, insert B₂ SMC: to follow all other SMCs but precede all other merging candidates; to follow all other SMCs, but precede the TMC, if available; or to follow the other SMCs and TMC, but precede all the other merging candidates.

The video coder may then apply an IVP process if an IVMC was available. After the IVP process, if the length of the list is more than N, the video coder truncates the list to contain only N entries. The IVP process may be applied to one or more of the derived SMCs, each of the derived SMCs, the TMC, the TMC and one or more of the SMCs, or any merging candidates or subset thereof, e.g., including combined bi-predictive and zero motion vector merging candidates.

In any case, the video coder compares the motion information of the one or more other merging candidates to the motion information of the IVMC. If the motion information is the same, the video coder prunes the merging candidate list to exclude one of the redundant merging candidates, e.g., an SMC, TMC, combined bi-predictive merging candidate, or zero motion vector merging candidate. The video coder may shift all merging candidates that are after the pruned candidate according to an order of the list up or left in the merging candidate list by 1. In some examples in which a candidate preceding the IVMC is removed, the video coder may insert the IVMC into the position of the removed merging candidate.

### EXAMPLE #3

A video coder invokes the derivation process for SMCs and the derivation process for a TMC as proposed for HEVC, e.g., as described above. The video coder then derives and inserts an IVMC, if available, into the merging candidate list, in any possible position of the candidate list. Then the video coder may insert the B₂ SMC into the merging candidate list, if the B₂ SMC is available and not equal to any of the existing merging candidates in the list. The video coder may, as examples, insert B₂: to follow all other SMCs but precede the TMC, if available; to follow the other SMCs and TMC, but precede all the other merging candidates, or as the last candidate in the merging candidate list.

The video coder may then apply an IVP process if an IVMC was available. After the IVP process, if the length of the list is more than N, the video coder truncates the list to contain only N entries. The IVP process may be applied to one or more of the derived SMCs, each of the derived SMCs, the TMC, or the TMC and one or more of the SMCs.

In any case, the video coder compares the motion information of the one or more other merging candidates to the motion information of the IVMC. If the motion information is the same, the video coder prunes the merging candidate list to exclude one of the redundant merging candidates, e.g., an SMC or TMC. The video coder may shift all merging candidates that are after the pruned candidate according to an order of the list up or left in the merging candidate list by 1. In some examples in which a candidate preceding the IVMC is removed, the video coder may insert the IVMC into the position of the removed merging candidate.

If the total number of merging candidates in the list remains less than the maximum number of candidates, the video coder may derive and insert combined bi-predictive candidates into the merging candidate list, e.g., according to values of combIdx and Table 2 (or Table 1), above. If the total number of merging candidates in the list still remains less than the maximum number of candidates, the video coder may insert zero motion vectors into the merging candidate list.

### EXAMPLE #4

A video coder invokes the merging candidate list derivation process proposed for HEVC, e.g., as described above. The merging candidate list construction process proposed for HEVC may include derivation and insertion of one or more combined bi-predictive merging candidates (e.g., according to a value of combIdx and Table 1, above) and zero motion vector merging candidates. The video coder then derives and inserts the IVMC, if available, into any position within the merging candidate list. The video coder then inserts the B₂ SMC into the candidate list, if it is available and, in these examples, without consideration of whether it is equal to any other merging candidate. The video coder may, as examples, insert the B₂ SMC: to follow all other SMCs but precede all other merging candidates; to follow all other SMCs, but precede the TMC, if available; to follow the other SMCs and TMC, but precede all the other merging candidates; or at the end of the merging candidate list.

The video coder may then apply a pruning process that compares any merging candidates to each other. If any merging candidates are redundant, the video coder prunes the list to exclude one of the redundant candidates, e.g., the candidate later in the list and/or with the greater merging candidate list index value. The excluded candidate may be an SMC, TMC, IVMC, combined bi-predictive merging candidate, or zero motion vector merging candidate. After the IVP process, if the length of the list is more than N, the video coder truncates the list to contain only N entries.

In either Example #1 or Example #3, if the total number of candidates after the IVP is less than N, and IVP has applied only to the SMCs and/or TMC, the video coder may apply a derivation process for combined bi-predictive merging or zero motion vector candidates. The derivation process may be as proposed for HEVC (e.g., based on Table 1) or for 3D-HEVC (e.g., based on Table 2). In some examples, a constraint may be that the video coder may apply a derivation process for combined bi-predictive merging or zero motion vector candidates when the length of the merging candidate list (N) is equal to 5 minus the signaled value for five_minus_max_num_merge cand (M). In some examples, when N is equal to 5-M, the video coder applies the derivation process for combined bi-predictive merging or zero motion vector candidates proposed for HEVC (e.g., based on Table 1), and when N is equal to 6-M, the video coder applies the derivation process for combined bi-predictive merging or zero motion vector candidates proposed for 3D-HEVC (e.g., based on Table 2).

In any of the examples described herein, e.g., Example #1, Example #2, or Example #3, the video coder may only apply the IVP process to one or more SMCs, rather than any additional merging candidates described with respect to those examples. Additionally, as an alternative to any of the examples described herein, e.g., Example #1, Example #2, Example #3, or Example #4, the video coder may not apply the B₂ insertion process described with respect to those examples. Additionally, as an alternative to any of the examples described herein, e.g., Example #1, Example #2, Example #3, or Example #4, N may be equal to (5-M), similar to the merge decoding process proposed for HEVC, but the video coder may replace the TMC with an IVMC regardless of whether an IVMC or TMC is available. In any example described herein, a video coder may insert an IMVC into the merging candidate list in any possible position. In the examples described herein, video encoder 20 may signal a flag in a slice header, picture parameter set, sequence parameter set, adaptation parameter set, or other syntax location, to indicate whether N is equal to 5-M or 6-M.

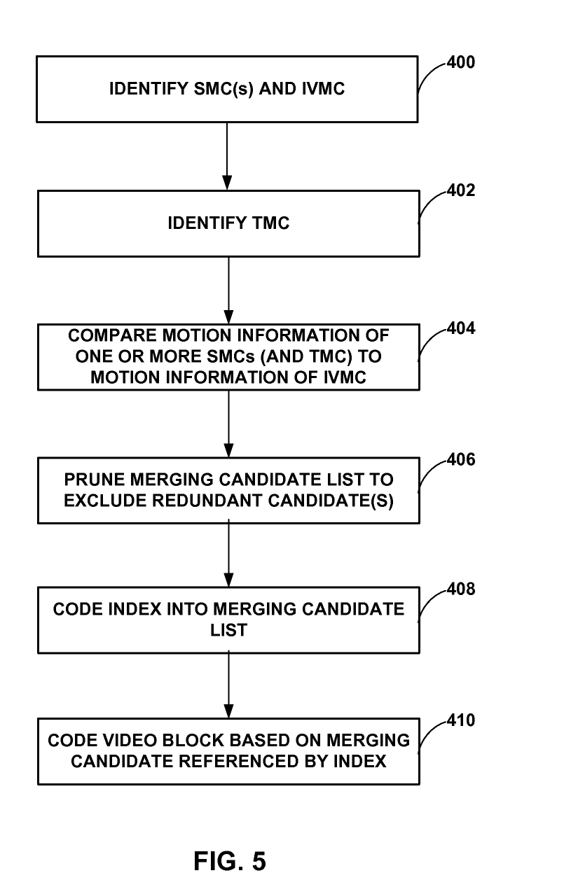

FIG. 5 is a flow diagram illustrating an example technique for constructing a merging candidate list for a current block of video data, and coding the current video block. The example technique of FIG. 5 may be implemented by a video coder, which may be a video encoder (e.g., video encoder 20), or video decoder (e.g., video decoder 30).

According to the example of FIG. 5, the video coder may identify, e.g., derive, and in some cases insert into the merging candidate list, one or more SMCs and an IVMC (400). The video coder also identifies a TMC (402). The video coder may compare the motion information of one or more identified SMCs, and in some cases an identified TMC, to the motion information of the IVMC (404).

If any of the merging candidates are redundant, the video coder may prune the redundant merging candidate from the merging candidate list (406). The pruned candidate may be an SMC, TMC, or IVMC, as examples. In some examples, as between two candidates with the same motion information, the pruned candidate may be the candidate associated with the greater index value in the merging candidate list, e.g., that is lower or more right in the list. Moreover, as discussed above, it should be understood that the “pruned” candidate may correspond to a candidate that was added to the list and subsequently removed, to a candidate that was intentionally omitted from being added based on the comparison, or otherwise is not included in the final candidate list, e.g., due to the comparison.

The video coder may then code a value of an index into the merging candidate list (408). The index value may specify which of the merging candidates is selected for coding the block of video data. For example, when performed by a video encoder, such as video encoder 20, the video encoder may determine which of the remaining candidates should be used to encode a motion vector for the block, and then encode data representative of the index. As another example, when performed by a video decoder, such as video decoder 30, the video decoder may decode data representative of the index, and then determine a motion vector to use to decode the block, based on the candidate in the candidate list to which the index corresponds. The video coder may then code the video block based on the merging candidate referenced by the coded index value (410).

Although described with respect to SMCs and, in some examples, a TMC, a video coder may additionally derive and insert other merging candidates, such as combined bi-predictive and zero motion vector candidates, into the merging candidate list. In some examples, the video coder may apply the IVP process to such merging candidates, e.g., compare the motion information of the IVMC to the motion information of such candidates, and exclude redundant ones of the candidates.

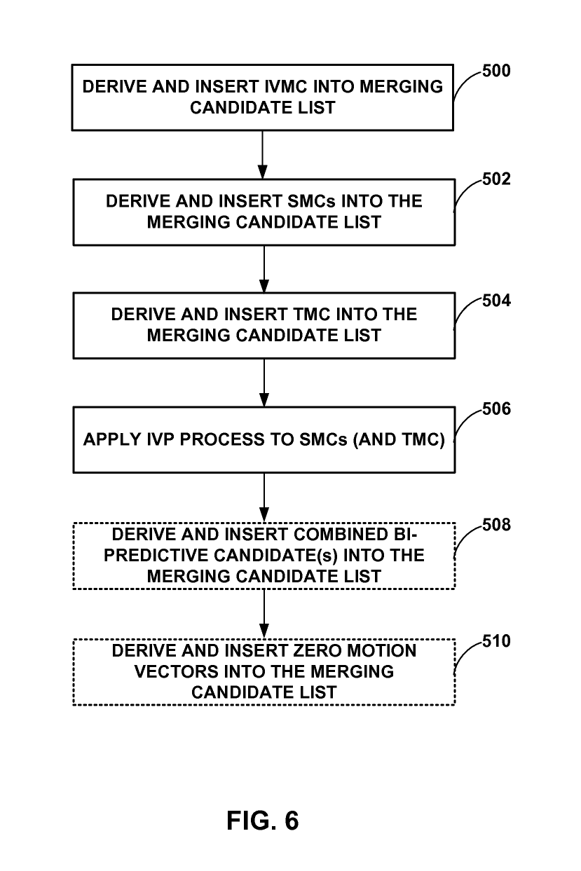

FIG. 6 is a flow diagram illustrating an example technique for constructing a merging candidate list for a current block of video data. The example technique of FIG. 6 may be implemented by a video coder, which may be a video encoder (e.g., video encoder 20), or video decoder (e.g., video decoder 30).

According to the example of FIG. 6, a video coder may derive and insert an IVMC into the merging candidate list (500). The video coder may also derive and insert one or more SMCs into the merging candidate list (502). The video coder may also derive and insert a TMC into the merging candidate list (504).

The video coder may apply an IVP process to the SMC(s) and, in some examples, the TMC (506). The IVP process may include comparing the motion information of the IVMC to the motion information of the SMC(s) and, in some examples, the TMC. According to the IVP process, if any of the merging candidates are redundant, the video coder may prune the redundant merging candidate from the merging candidate list. The pruned candidate may be an SMC, TMC, or IVMC, as examples. In some examples, as between two candidates with the same motion information, the pruned candidate may be the candidate associated with the greater index value in the merging candidate list, e.g., that is lower or more right in the list. Alternatively, as discussed above, rather than deriving and inserting the various candidates into the list and then performing IVP process, the video coder may perform the IVP process substantially concurrently with generation of the list, such that the video coder avoids adding redundant merging candidates into the merging candidate list.

If, after the IVP process, the number of merging candidates in the list is greater than the predetermined maximum size of the list, the video coder may truncate the list. On the other hand, if the number of number of merging candidates in the list is less than the predetermined maximum size of the list, the video coder may derive and insert one or more combined bi-predictive merging candidates into the list (508). If the number of merging candidates in the list remains less than the predetermined maximum size of the list, e.g., sufficient combined bi-predictive merging candidates were not available, the video coder may insert one or more zero motion vectors into the merging candidate list (510).

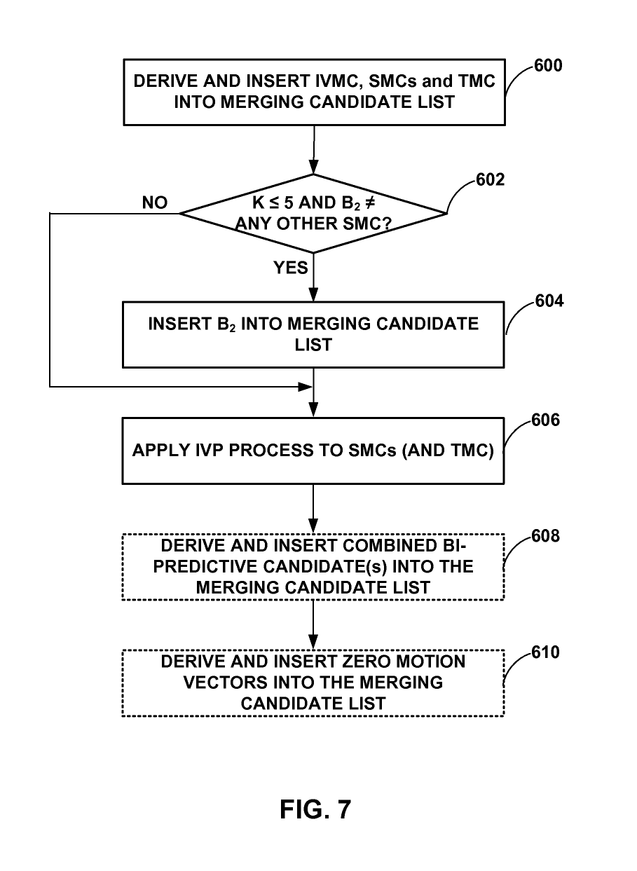

FIG. 7 is a flow diagram illustrating an example technique for constructing a merging candidate list for a current block of video data. The example technique of FIG. 7 may be implemented by a video coder, which may be a video encoder (e.g., video encoder 20), or video decoder (e.g., video decoder 30).

According to the example of FIG. 7, the video coder derives, and inserts into the merging candidate list, an IVMC, one or more SMCs, and a TMC (600). The video coder then determines if the number of merging candidates including the SMCs and TMC is less than 5, e.g., if the number of SMCs is less than 4, and whether the motion information of the B₂ candidate is different than any other SMC (602). If so, the video coder inserts the B₂ candidate into the list, e.g., in any of a variety of positions as described herein (604). In either case, the video coder may then apply the IVP process to the SMCs (e.g., including B₂) and, in some examples, the TMC (606). Again, it should be understood, as discussed above, that rather than deriving and inserting the various candidates into the list and then performing IVP process, the video coder may perform the IVP process substantially concurrently with generation of the list, such that the video coder avoids adding redundant merging candidates into the merging candidate list. Based on the number of candidates remaining in the merging candidate list after the IVP process, the video coder may truncate the list, or add combined bi-predictive (608) or zero motion vector (610) candidates to the list.

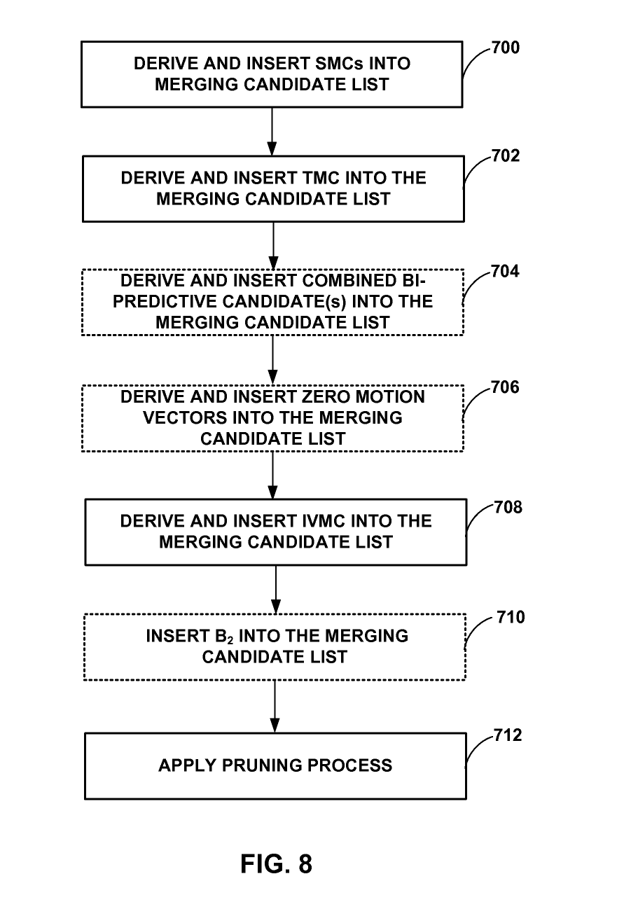

FIG. 8 is a flow diagram illustrating an example technique for constructing a merging candidate list for a current block of video data. The example technique of FIG. 8 may be implemented by a video coder, which may be a video encoder (e.g., video encoder 20), or video decoder (e.g., video decoder 30).

According to the example of FIG. 8, the video coder derives SMCs, and inserts one or more of the SMCs (other than the B₂ candidate) into the merging candidate list (700). The video coder also derives and inserts a TMC, if available, into the merging candidates list (702). Depending on the number of merging candidates (SMCs and TMC) in the list, the video coder may additionally derive and insert combined bi-predictive (704) or zero motion vector (706) candidates into the list.

The video coder may then derive and insert an IVMC into the merging candidate list, in any position, if available (708). Additionally, the video coder may insert the B₂ SMC into the merging candidate list (710). The video coder may always insert the B₂ SMC into the merging candidate list, or insert the B₂ SMC when unequal to any other SMC (or any other merging candidate, in some examples).

The video coder may then apply a pruning process to the merging candidates (712). In some examples, the video coder may compare the motion information of the IVMC to other merging candidates, such as any one or more of SMCs, TMCs, combined bi-predictive candidates, or zero motion vector candidates. In some examples, the video coder may compare the motion information of any merging candidate to any other merging candidate. Again, although shown as performing the pruning process after inserting candidates into the list, it should be understood that a substantially similar method may be performed in which the pruning process is used to avoid adding redundant merge candidates into the list.

According to the pruning process, if any of the compared merging candidates are redundant, the video coder may prune the redundant merging candidate from the merging candidate list. The pruned candidate may be an SMC, TMC, IVMC, combined bi-predictive candidate, or zero motion vector, as examples. In some examples, as between two candidates with the same motion information, the pruned candidate may be the candidate associated with the greater index value in the merging candidate list, e.g., that is lower or more right in the list. If, after the IVP process, the number of merging candidates in the list is greater than the predetermined maximum size of the list, the video coder may truncate the list.

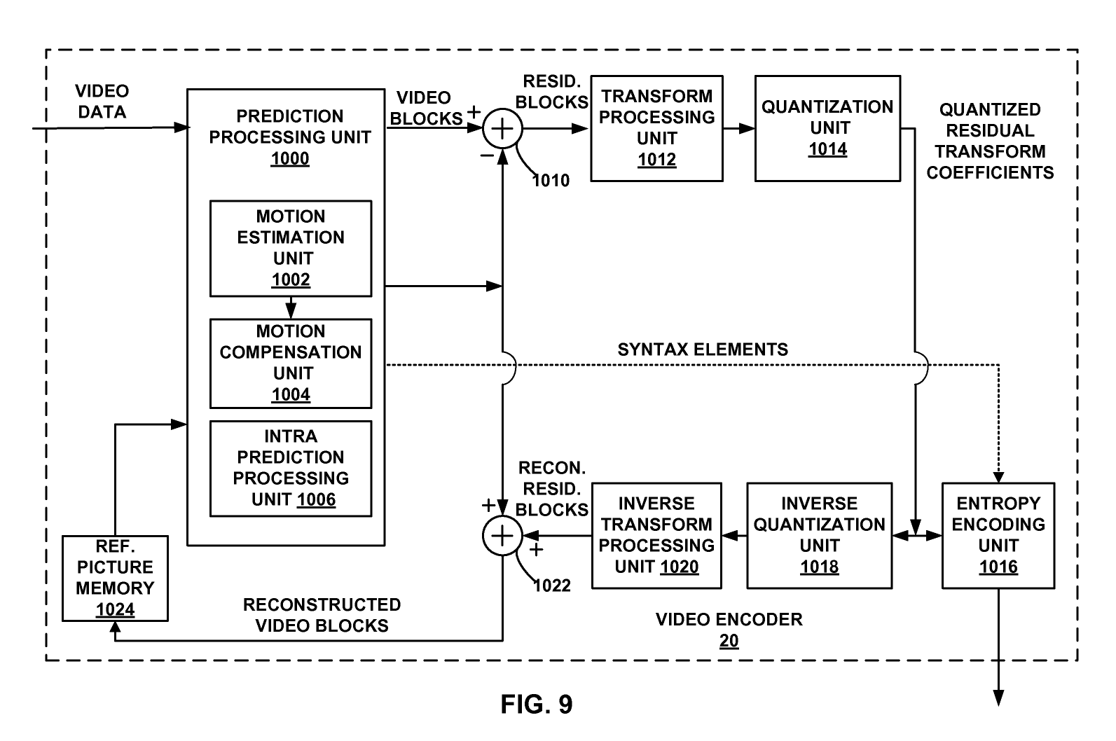

FIG. 9 is a block diagram illustrating an example of a video encoder 20 that may implement the techniques described in this disclosure for constructing a merging candidates list for encoding a video block. Video encoder 20 may be configured to perform any or all of the techniques of this disclosure, e.g., perform any of the example techniques illustrated in FIGS. 5-8. FIG. 9 is provided for purposes of explanation, and should not be considered limiting of the techniques as broadly exemplified and described in this disclosure. For purposes of explanation, this disclosure describes video encoder 20 in the context of HEVC and 3D-HEVC coding. However, the techniques of this disclosure may be applicable to other coding standards or methods.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 9, video encoder 20 receives video data. In the example of FIG. 9, video encoder 20 a prediction processing unit 1000, a summer 1010, a transform processing unit 1012, a quantization unit 1014, an entropy encoding unit 1016, and a reference picture memory 1024. Prediction processing unit 1000 includes a motion estimation unit 1002, motion compensation unit 1004, and an intra-prediction processing unit 1006.

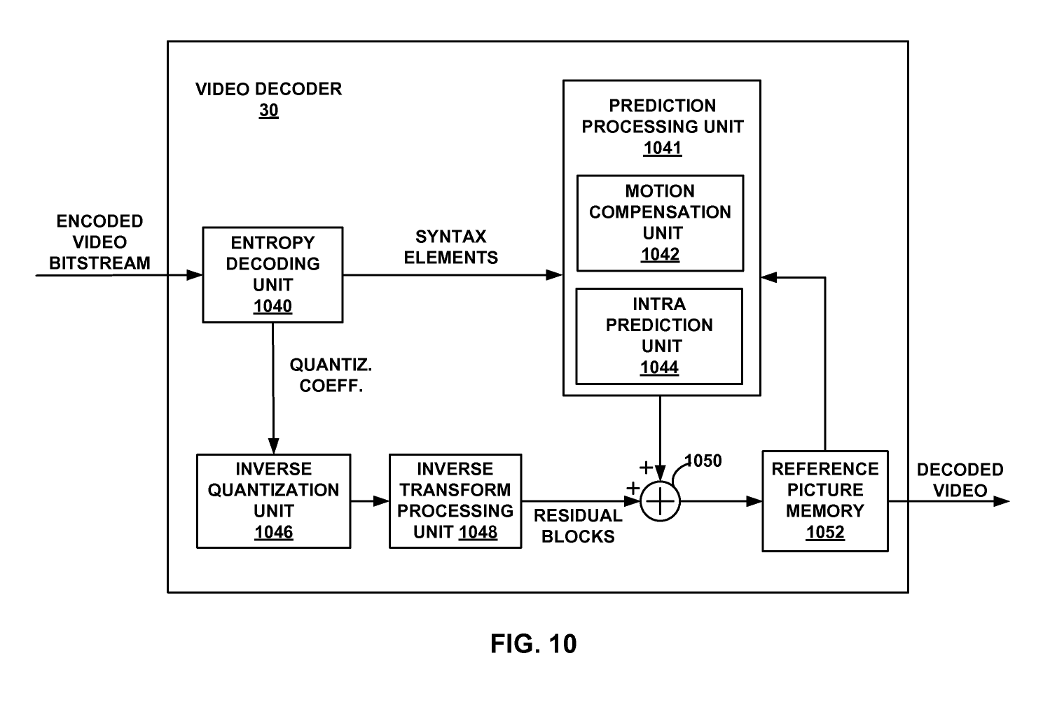

For video block reconstruction, video encoder 20 also includes inverse quantization unit 1018, inverse transform processing unit 1020, and a summer 1022. A deblocking filter (not shown in FIG. 10) may also be included to filter block boundaries to remove blockiness artifacts from reconstructed video. If desired, the deblocking filter would typically filter the output of summer 1022. Additional filters (in loop or post loop) may also be used in addition to the deblocking filter. Such filters are not shown for brevity, but if desired, may filter the output of summer 1010 (as an in-loop filter).

During the encoding process, video encoder 20 receives a video picture or slice to be coded. Prediction processing unit 1000 divides the picture or slice into multiple video blocks. Motion estimation unit 1002 and motion compensation unit 1004 perform inter-predictive coding of the received video block relative to one or more blocks in one or more reference pictures stored in reference picture memory 1024 to provide temporal or inter-view prediction. Intra-prediction processing unit 1006 may alternatively perform intra-predictive coding of the received video block relative to one or more neighboring blocks in the same picture or slice as the block to be coded to provide spatial prediction. Video encoder 20 may perform multiple coding passes, e.g., to select an appropriate coding mode for each block of video data.

Moreover, prediction processing unit 1000 may partition blocks of video data into sub-blocks, based on evaluation of previous partitioning schemes in previous coding passes. For example, prediction processing unit 1000 may initially partition a picture or slice into LCUs, and partition each of the LCUs into sub-CUs according to different prediction modes based on rate-distortion analysis (e.g., rate-distortion optimization). Prediction processing unit 1000 may produce a quadtree data structure indicative of partitioning of an LCU into sub-CUs. Leaf-node CUs of the quadtree may include one or more PUs and one or more TUs.

Prediction processing unit 1000 may select one of the coding modes (intra-coding or inter-coding) e.g., based on error results, and provide the resulting intra-coded or inter-coded block to summer 1010 to generate residual block data and to summer 1022 to reconstruct the encoded block for use as part of a reference picture stored in reference picture memory 1024. Prediction processing unit 1000 also provides syntax elements, such as motion vectors, intra-mode indicators, partition information, reference picture index values, merging candidate list index values, and other such syntax information, to entropy encoding unit 1016 for use by video decoder 30 in decoding the video blocks.

Prediction processing unit 1000, e.g., motion estimation unit 1002 and/or motion compensation unit 1004, may perform the techniques described in this disclosure for constructing a merging candidate list. For example, prediction processing unit 1000, e.g., motion estimation unit 1002 and/or motion compensation unit 1004, may perform any of the example techniques of FIG. 5-8. Motion estimation unit 1002 and motion compensation unit 1004 may be highly integrated, but are illustrated separately for conceptual purposes.

Motion estimation, performed by motion estimation unit 1002, is the process of generating motion vectors or disparity motion vectors, which estimate motion for video blocks. A motion vector or disparity motion vector may indicate the displacement of a current PU of a current video block within a current picture relative to a predictive block within a reference picture, e.g., a temporal reference picture or an inter-view reference picture. A predictive block is a block that is found to closely match the block to be coded, in terms of pixel difference, which may be determined by sum of absolute difference (SAD), sum of square difference (SSD), or other difference metrics.

In some examples, video encoder 20 may calculate values for sub-integer pixel positions of reference pictures stored in reference picture memory 1024. For example, video encoder 20 may interpolate values of one-quarter pixel positions, one-eighth pixel positions, or other fractional pixel positions of the reference picture. Therefore, motion estimation unit 1002 may perform a motion search relative to the full pixel positions and fractional pixel positions and output a motion vector with fractional pixel precision. Motion estimation unit 1002 may select the reference picture from a reference picture list, e.g., List 0 or List 1, which identifies one or more reference pictures stored in reference picture memory 1024. Motion estimation unit 1002 sends the calculated motion vector or disparity motion vector to entropy encoding unit 1016 and motion compensation unit 1004. In some examples described herein, in which a merge mode is employed, rather than sending the calculated prediction vector to the entropy encoding unit, motion estimation unit 1002 sends an index into merging candidate list to the entropy encoding unit. A video decoder may use the same techniques as encoder 20 to construct the merging candidate list, and may select a merging candidate for decoding the video block based on the index signaled by motion estimation unit 1002.

Motion compensation, performed by motion compensation unit 1004, may involve fetching or generating the predictive block based on the prediction vector determined by motion estimation unit 1002. Again, motion estimation unit 1002 and motion compensation unit 1004 may be functionally integrated, in some examples. Upon receiving the prediction vector for the PU of the current video block, motion compensation unit 1004 may locate the predictive block to which the prediction vector points in one of the reference picture lists. Summer 1010 forms a residual video block by subtracting pixel values of the predictive block from the pixel values of the current video block being coded, forming pixel difference values. In general, motion estimation unit 1002 performs motion estimation relative to luma components, and motion compensation unit 1004 uses prediction vectors calculated based on the luma components for both chroma components and luma components.

Intra-prediction processing unit 1006 may intra-predict a current block, as an alternative to the inter-prediction performed by motion estimation unit 1002 and motion compensation unit 1004. In particular, intra-prediction processing unit 1006 may determine an intra-prediction mode to use to encode a current block. In some examples, intra-prediction processing unit 1006 may encode a current block using various intra-prediction modes, e.g., during separate encoding passes, and intra-prediction processing unit 1006 may select an appropriate intra-prediction mode to use from the tested modes.

For example, intra-prediction processing unit 1006 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction processing unit 1006 may calculate ratios from the distortions and rates for the various encoded blocks to determine which intra-prediction mode exhibits the best rate-distortion value for the block.

After selecting an intra-prediction mode for a block, intra-prediction processing unit 1006 may provide information indicative of the selected intra-prediction mode for the block to entropy encoding unit 1016. Entropy encoding unit 1016 may encode the information indicating the selected intra-prediction mode for use by video decoder 30 in decoding the video block. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from prediction module 1001 from the original video block being coded. Summer 1010 represents the component or components that perform this subtraction operation. Transform processing unit 1012 applies a transform, such as a discrete cosine transform (DCT) or a conceptually similar transform, to the residual block, producing a video block comprising residual transform coefficient values. Transform processing unit 1012 may perform other transforms which are conceptually similar to DCT. Wavelet transforms, integer transforms, sub-band transforms or other types of transforms could also be used. In any case, transform processing unit 1012 applies the transform to the residual block, producing a block of residual transform coefficients. The transform may convert the residual information from a pixel value domain to a transform domain, such as a frequency domain. Transform processing unit 1012 may send the resulting transform coefficients to quantization unit 1014.

Quantization unit 1014 quantizes the values of the transform coefficients to further reduce bit rate. The quantization process may reduce the bit depth associated with some or all of the coefficients. The degree of quantization may be modified by adjusting a quantization parameter. In some examples, quantization unit 1014 may then perform a scan of the matrix including the quantized transform coefficients. Alternatively, entropy encoding unit 1016 may perform the scan.

Following quantization, entropy encoding unit 1016 entropy encodes the quantized transform coefficients. For example, entropy encoding unit 1016 may perform context adaptive variable length coding (CAVLC), context adaptive binary arithmetic coding (CABAC), syntax-based context-adaptive binary arithmetic coding (SBAC), probability interval partitioning entropy (PIPE) encoding or another entropy encoding technique. In the case of context-based entropy encoding, context may be based on neighboring blocks. Following the entropy encoding by entropy encoding unit 1016, the encoded bitstream may be transmitted to another device (e.g., video decoder 30) or archived for later transmission or retrieval.

Entropy encoding unit 1016 may also be configured to entropy encode motion information for blocks that are inter-predicted and intra-prediction information for blocks that are intra-predicted. For example, entropy encoding unit 1016 may be configured to entropy encode data representative of a motion vector for a block in merge mode. In accordance with the techniques of this disclosure, entropy encoding data representative of a motion vector in merge mode may include pruning a merging candidate list (after constructing the list or while constructing the list) such that redundant merge candidates are omitted from the constructed list. Entropy encoding unit 1016 may perform this pruning process using any or all of the techniques described above, e.g., with respect to FIGS. 5-8. Following the pruning process, entropy encoding unit 1016 may entropy encode an index that corresponds to a merge candidate having a motion vector that is used to predict the corresponding block.

Inverse quantization unit 1018 and inverse transform processing unit 1020 apply inverse quantization and inverse transformation, respectively, to reconstruct the residual block in the pixel domain and then add the residual to the corresponding predictive block to reconstruct the coded block, e.g., for later use as a reference block. Motion compensation unit 1004 may calculate a reference block by adding the residual block to a predictive block of one of the reference pictures of reference picture memory 1024. Motion compensation unit 1004 may also apply one or more interpolation filters to the reconstructed residual block to calculate sub-integer pixel values for use in motion estimation. Summer 1022 adds the reconstructed residual block to the motion compensated prediction block produced by motion compensation unit 1004 to produce a reconstructed video block for storage in reference picture memory 1024. The reconstructed video block may be used by motion estimation unit 1012 and motion compensation unit 1014 as a reference block to inter-code a block in a subsequent picture, e.g., using the motion vector prediction and inter-view coding techniques described herein.

In this manner, video encoder 20 of FIG. 9 represents an example of a video encoder configured to identify one or more SMCs and an IVMC for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. Video encoder 20 represents an example of a video encoder further configured to compare the motion information of at least one of the SMCs to the motion information of the IVMC and, if the SMC has the same motion information as the IVMC, prune the merging candidate list to exclude the one of the merging candidates from the merging candidate list. Video encoder 20 represents an example of a video encoder further configured to encode an index that refers to one of the merging candidates from the merging candidate list for the current video block, and encode the current video block based on the one of the merging candidates from the merging candidate list referenced by the index.

FIG. 10 is a block diagram illustrating an example of a video decoder 30 that may implement the techniques described in this disclosure for constructing a merging candidate list. Video decoder 30 may be configured to perform any or all of the techniques of this disclosure, e.g., perform any of the example techniques illustrated in FIGS. 5-8. FIG. 10 is provided for purposes of explanation and is not limiting on the techniques as broadly exemplified and described in this disclosure. For purposes of explanation, this disclosure describes video decoder 30 in the context of HEVC and 3D-HEVC video coding. However, the techniques of this disclosure may be applicable to other video coding standards or methods.

In the example of FIG. 10, video decoder 30 includes an entropy decoding unit 1040, prediction processing unit 1041, inverse quantization unit 1046, inverse transformation processing unit 1048, reference picture memory 1052 and summer 1050. Prediction processing unit 1041 includes a motion compensation unit 1042 and intra prediction unit 1044. Video decoder 30 may, in some examples, perform a decoding pass generally reciprocal to the encoding pass described with respect to video encoder 20 (FIG. 10). Motion compensation unit 1042 may generate prediction data based on motion vectors or, according to the techniques described herein, based a merging candidate list index value received from entropy decoding unit 1040. Intra-prediction unit 1044 may generate prediction data based on intra-prediction mode indicators received from entropy decoding unit 1040.

During the decoding process, video decoder 30 receives an encoded video bitstream that represents video blocks of an encoded video slice and associated syntax elements from video encoder 20. Entropy decoding unit 1040 of video decoder 30 entropy decodes the bitstream to generate quantized coefficients, prediction vectors, merging candidate list indices, intra-prediction mode indicators, and other syntax elements, which are forwarded to prediction processing unit 1041. Video decoder 30 may receive the syntax elements at the video slice level and/or the video block level.

When the video slice is coded as an intra-coded (I) slice, intra prediction unit 1044 may generate prediction data for a video block of the current video slice based on a signaled intra prediction mode and data from previously decoded blocks of the current picture. When the video slice is coded as an inter-coded (i.e., B, P or GPB) slice, motion compensation unit 1042 produces reference blocks for a video block of the current video slice based on the prediction vectors, or reference picture and MVP candidate list indices, and other syntax elements received from entropy decoding unit 1040. The reference blocks may be produced from one of the temporal or inter-view reference pictures within reference picture memory 1052. The reference pictures may be listed in one of the reference picture lists, e.g., List 0 and List 1, constructed by video decoder 30 using default construction techniques.

Entropy decoding unit 1040 may decode data representative of an index that references a merge candidate in a pruned merging candidate list. Prediction processing unit 1041, e.g., motion compensation unit 1042, may perform any of the merging candidate list construction for 3D video coding techniques described herein. For example, prediction module 1041, e.g., motion compensation unit 1042, may perform any of the example techniques illustrated by FIGS. 5-8. Accordingly, prediction processing unit 1041 may receive information from the encoder in the bitstream, such as a merging candidate list index value. Prediction processing unit 1041 may construct a merging candidate list using the same techniques used by the encoder, e.g., the techniques described with respect to FIGS. 5-8, or otherwise herein, and select one of the merging candidates from the list for inter-prediction of a current video block based on the motion information of the referenced merging candidate.

Motion compensation unit 1042 may also perform interpolation based on interpolation filters. Motion compensation unit 1042 may use interpolation filters as used by video encoder 20 during encoding of the video blocks to calculate interpolated values for sub-integer pixels of reference blocks. In this case, motion compensation unit 1042 may determine the interpolation filters used by video encoder 20 from the received syntax elements and use the interpolation filters to produce predictive blocks.

Inverse quantization unit 1046 inverse quantizes, i.e., de-quantizes, the quantized transform coefficients provided in the bitstream and decoded by entropy decoding unit 1040. The inverse quantization process may include use of a quantization parameter QP_{Y} calculated by video decoder 30 for each video block in the video slice to determine a degree of quantization and, likewise, a degree of inverse quantization that should be applied. Inverse transform processing unit 1048 applies an inverse transform, e.g., an inverse DCT, an inverse integer transform, or a conceptually similar inverse transform process, to the transform coefficients in order to produce residual blocks in the pixel domain.

After motion compensation unit 1042 generates the predictive block for the current video block, video decoder 30 forms a decoded video block by summing the residual blocks from inverse transform unit 1048 with the corresponding predictive blocks generated by motion compensation unit 1042. Summer 1050 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given picture are then stored in reference picture memory 1052, which stores reference pictures used for subsequent motion compensation. Reference picture memory 1052 may also store the decoded video for later presentation on a display device, such as display device 32 of FIG. 1.

In this manner, video decoder 30 of FIG. 10 represents an example of a video decoder configured to identify one or more SMCs and an IVMC for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit. Video decoder 30 of FIG. 10 represents an example of a video decoder further configured to compare the motion information of at least one of the SMCs to the motion information of the IVMC and, if the SMC has the same motion information as the IVMC, prune the merging candidate list to exclude the one of the merging candidates from the merging candidate list. Video decoder 30 of FIG. 10 represents an example of a video decoder further configured to decode an index that refers to one of the merging candidates from the merging candidate list for the current video block, and decode the current video block based on the one of the merging candidates from the merging candidate list referenced by the index.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

In still other examples, this disclosure may be directed to a computer-readable storage medium that stores compressed video data, wherein the video data is compressed according to one or more of the techniques described herein. The data structures stored on the computer readable medium may include syntax elements that define the video data that is compressed according to one or more of the techniques described herein.

Various examples have been described. These and other examples are within the scope of the following claims.

What is claimed is:

1. A method of decoding video data according to a merge mode and/or a skip mode, the method comprising:
identifying one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
comparing the motion information of at least one of the SMCs to the motion information of the IVMC;
if the SMC has the same motion information as the IVMC, pruning the merging candidate list to exclude the one of the merging candidates from the merging candidate list;
decoding an index that refers to one of the merging candidates from the merging candidate list for the current video block; and
decoding the current video block based on the one of the merging candidates from the merging candidate list referenced by the index.

2. The method of claim 1, wherein comparing the motion information of at least one of the SMCs to the motion information of the IVMC comprises comparing the motion information of an A₁ SMC to the motion information of the IVMC.

3. The method of claim 1, wherein comparing the motion information of at least one of the SMCs to the motion information of the IVMC comprises comparing the motion information of an A₁ SMC and a B₁ SMC to the motion information of the IVMC.

4. The method of claim 1, wherein comparing the motion information of at least one of the SMCs to the motion information of the IVMC comprises comparing the motion information of a first one of the SMCs according to a predetermined order of consideration of the SMCs to the motion information of the IVMC.

5. The method of claim 1, wherein comparing the motion information of at least one of the SMCs to the IVMC comprises comparing the motion information of first and second ones of the SMCs according to a predetermined order of consideration of the SMCs to the motion information of the IVMC.

6. The method of claim 1, wherein comparing the motion information of at least one of the SMCs to the IVMC comprises comparing the motion information of all of the SMCs identified for inclusion in the merging candidate list to the motion information of the IVMC.

7. The method of claim 1, wherein pruning the merging candidate list to exclude the one of the merging candidates from the merging candidate list comprises pruning the merging candidate list to exclude the at least one of the SMCs.

8. The method of claim 7, further comprising shifting merging candidates below the excluded SMC according to an order of the merging candidate list up in the merging candidate list.

9. The method of claim 7, further comprising placing the IVMC into a position of the excluded SMC within the merging candidate list.

10. The method of claim 1, wherein pruning the merging candidate list to exclude the one of the merging candidates from the merging candidate list comprises excluding the one of the merging candidates having a greater index value in the merging candidate list.

11. The method of claim 1, further comprising including a temporal merging candidate (TMC) in the merging candidate list, wherein the TMC comprises motion information derived from a block in the first view in a previously-coded access unit of the video data.

12. The method of claim 11, further comprising:
comparing the motion information of the TMC to the motion information of the IVMC; and
pruning the merging candidate list to exclude the TMC if the TMC has the same motion information as the IVMC.

13. The method of claim 1, further comprising, if a number of merging candidates in the merging candidate list after the comparison to the motion information of the IVMC is less than a maximum number of merging candidates for the merging candidate list, including at least one of a bi-predictive merging candidate or a zero motion vector candidate in the merging candidate list.

14. The method of claim 1, wherein the IVMC is prioritized below one or more of the SMCs when pruning the merging candidate list to exclude the one of the merging candidates.

15. The method of claim 1, wherein the IVMC is prioritized above one or more of the SMCs when pruning the merging candidate list to exclude the one of the merging candidates.

16. A method of encoding video data according to a merge mode and/or a skip mode, the method comprising:
identifying one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
comparing the motion information of at least one of the SMCs to the motion information of the IVMC;
if the SMC has the same motion information as the IVMC, pruning the merging candidate list to exclude the one of the merging candidates from the merging candidate list;
encoding an index that refers to one of the merging candidates from the merging candidate list for the current video block; and
encoding the current video block based on the one of the merging candidates from the merging candidate list referenced by the index.

17. The method of claim 16, wherein comparing the motion information of at least one of the SMCs to the motion information of the IVMC comprises comparing the motion information of an A₁ SMC to the motion information of the IVMC.

18. The method of claim 16, wherein comparing the motion information of at least one of the SMCs to the motion information of the IVMC comprises comparing the motion information of an A₁ SMC and a B₁ SMC to the motion information of the IVMC.

19. The method of claim 16, wherein comparing the motion information of at least one of the SMCs to the motion information of the IVMC comprises comparing the motion information of a first one of the SMCs according to a predetermined order of consideration of the SMCs to the motion information of the IVMC.

20. The method of claim 16, wherein comparing the motion information of at least one of the SMCs to the IVMC comprises comparing the motion information of first and second ones of the SMCs according to a predetermined order of consideration of the SMCs to the motion information of the IVMC.

21. The method of claim 16, wherein comparing the motion information of at least one of the SMCs to the IVMC comprises comparing the motion information of all of the SMCs identified for inclusion in the merging candidate list to the motion information of the IVMC.

22. The method of claim 16, wherein pruning the merging candidate list to exclude the one of the merging candidates from the merging candidate list comprises pruning the merging candidate list to exclude the at least one of the SMCs.

23. The method of claim 22, further comprising shifting merging candidates below the excluded SMC according to an order of the merging candidate list up in the merging candidate list.

24. The method of claim 22, further comprising placing the IVMC into a position of the excluded SMC within the merging candidate list.

25. The method of claim 16, wherein pruning the merging candidate list to exclude the one of the merging candidates from the merging candidate list comprises excluding the one of the merging candidates having a greater index value in the merging candidate list.

26. The method of claim 16, further comprising including a temporal merging candidate (TMC) in the merging candidate list, wherein the TMC comprises motion information derived from a block in the first view in a previously-coded access unit of the video data.

27. The method of claim 26, further comprising:
comparing the motion information of the TMC to the motion information of the IVMC; and
pruning the merging candidate list to exclude the TMC if the TMC has the same motion information as the IVMC.

28. The method of claim 16, further comprising, if a number of merging candidates in the merging candidate list after the comparison to the motion information of the IVMC is less than a maximum number of merging candidates for the merging candidate list, including at least one of a bi-predictive merging candidate or a zero motion vector candidate in the merging candidate list.

29. The method of claim 16, wherein the IVMC is prioritized below one or more of the SMCs when pruning the merging candidate list to exclude the one of the merging candidates.

30. The method of claim 16, wherein the IVMC is prioritized above one or more of the SMCs when pruning the merging candidate list to exclude the one of the merging candidates.

31. A device that decodes video data according to a merge mode and/or a skip mode, the device comprising a video decoder configured to:
identify one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
compare the motion information of at least one of the SMCs to the motion information of the IVMC;
if the SMC has the same motion information as the IVMC, prune the merging candidate list to exclude the one of the merging candidates from the merging candidate list;
decode an index that refers to one of the merging candidates from the merging candidate list for the current video block; and
decode the current video block based on the one of the merging candidates from the merging candidate list referenced by the index.

32. The device of claim 31, wherein the video decoder is configured to compare the motion information of at least one of the SMCs to the motion information of the IVMC by at least comparing the motion information of an A₁ SMC to the motion information of the IVMC.

33. The device of claim 31, wherein the video decoder is configured to compare the motion information of at least one of the SMCs to the motion information of the IVMC by at least comparing the motion information of an A₁ SMC and a B₁ SMC to the motion information of the IVMC.

34. The device of claim 31, wherein the video decoder is configured to compare the motion information of at least one of the SMCs to the motion information of the IVMC by at least comparing the motion information of a first one of the SMCs according to a predetermined order of consideration of the SMCs to the motion information of the IVMC.

35. The device of claim 31, wherein the video decoder is configured to compare the motion information of at least one of the SMCs to the motion information of the IVMC by at least comparing the motion information of first and second ones of the SMCs according to a predetermined order of consideration of the SMCs to the motion information of the IVMC.

36. The device of claim 31, wherein the video decoder is configured to compare the motion information of at least one of the SMCs to the motion information of the IVMC by at least comparing the motion information of all of the SMCs identified for inclusion in the merging candidate list to the motion information of the IVMC.

37. The device of claim 31, wherein the video decoder is configured to prune the merging candidate list to exclude the at least one of the SMCs.

38. The device of claim 37, wherein the video decoder is further configured to shift merging candidates below the excluded SMC according to an order of the merging candidate list up in the merging candidate list.

39. The device of claim 37, wherein the video decoder is further configured to place the IVMC into a position of the excluded SMC within the merging candidate list.

40. The device of claim 31, wherein the video decoder is configured to prune the merging candidate list to exclude the one of the merging candidates from the merging candidate list by at least excluding the one of the merging candidates having a greater index value in the merging candidate list.

41. The device of claim 31, wherein the video decoder is further configured to include a temporal merging candidate (TMC) in the merging candidate list, wherein the TMC comprises motion information derived from a block in the first view in a previously-coded access unit of the video data.

42. The device of claim 41, wherein the video decoder is further configured to:
compare the motion information of the TMC to the motion information of the IVMC; and
prune the merging candidate list to exclude the TMC if the TMC has the same motion information as the IVMC.

43. The device of claim 31, wherein the video decoder is further configured to, if a number of merging candidates in the merging candidate list after the comparison to the motion information of the IVMC is less than a maximum number of merging candidates for the merging candidate list, include at least one of a bi-predictive merging candidate or a zero motion vector candidate in the merging candidate list.

44. The device of claim 31, wherein the video decoder prioritizes the IVMC below one or more of the SMCs when pruning the merging candidate list to exclude the one of the merging candidates.

45. The device of claim 31, wherein the video decoder prioritizes the IVMC above one or more of the SMCs when pruning the merging candidate list to exclude the one of the merging candidates.

46. The device of claim 31, wherein the device comprises at least one of:
an integrated circuit implementing the video decoder;
a microprocessor implementing the video decoder; and
a wireless communication device including the video decoder.

47. A device that encodes video data according to a merge mode and/or a skip mode, the device comprising a video encoder configured to:
identify one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
compare the motion information of at least one of the SMCs to the motion information of the IVMC;
if the SMC has the same motion information as the IVMC, prune the merging candidate list to exclude the one of the merging candidates from the merging candidate list;
encode an index that refers to one of the merging candidates from the merging candidate list for the current video block; and
encode the current video block based on the one of the merging candidates from the merging candidate list referenced by the index.

48. The device of claim 47, wherein the video encoder is configured to compare the motion information of at least one of the SMCs to the motion information of the IVMC by at least comparing the motion information of at least one of an A₁ SMC or a B₁ SMC to the motion information of the IVMC.

49. The device of claim 47, wherein the video encoder is configured to compare the motion information of at least one of the SMCs to the motion information of the IVMC by at least comparing the motion information of at least one of first or second ones of the SMCs according to a predetermined order of consideration of the SMCs to the motion information of the IVMC.

50. The device of claim 47, wherein the video encoder is further configured to:
include a temporal merging candidate (TMC) in the merging candidate list, wherein the TMC comprises motion information derived from a block in the first view in a previously-coded access unit of the video data;
compare the motion information of the TMC to the motion information of the IVMC; and
prune the merging candidate list to exclude the TMC if the TMC has the same motion information as the IVMC.

51. A device that codes video data according to a merge mode and/or a skip mode, the device comprising:
means for identifying one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
means for comparing the motion information of at least one of the SMCs to the motion information of the IVMC;
means for, if the SMC has the same motion information as the IVMC, pruning the merging candidate list to exclude the one of the merging candidates from the merging candidate list;
means for coding an index that refers to one of the merging candidates from the merging candidate list for the current video block; and
means for coding the current video block based on the one of the merging candidates from the merging candidate list referenced by the index.

52. A computer-readable storage medium having instructions stored thereon that, when executed by one or more processors of a video coder, cause the video coder to:
identify one or more spatial merging candidates (SMCs) and an inter-view merging candidate (IVMC) for inclusion in a merging candidate list for a current video block in a first view of a current access unit of video data, wherein the SMCs comprise motion information derived from respective spatially-neighboring blocks of the current video block, and the IVMC comprises motion information that is one of derived from a block in a second view of the current access unit or converted from a disparity vector to a disparity motion vector for the current video block in the first view of the current access unit;
compare the motion information of at least one of the SMCs to the motion information of the IVMC;
if the SMC has the same motion information as the IVMC, prune the merging candidate list to exclude the one of the merging candidates from the merging candidate list;
code an index that refers to one of the merging candidates from the merging candidate list for the current video block; and
code the current video block based on the one of the merging candidates from the merging candidate list referenced by the index.
